(19) United States
(12) Patent Application Publication
(10) Pub. No.: US 2026/0214706 A1
(43) Pub. Date: Jul. 23, 2026

(54) METHOD AND DEVICE FOR DIRECT COMMUNICATION IN WIRELESS LAN SUPPORTING EMLSR

(71) Applicant: Electronics and Telecommunications Research Institute, Daejeon (KR)

(72) Inventors: Sung Hyun HWANG, Daejeon (KR); Kyu Min KANG, Daejeon (KR); Yong Ho KIM, Incheon (KR); Ju Seong MOON, Osan-si, Gyeonggi-do (KR)

(21) Appl. No.: 18/842,019

(22) PCT Filed: Mar. 10, 2023
(86) PCT No.: PCT/KR2023/003324

§ 371 Date: Aug. 27, 2024

(30) Foreign Application Priority Data
Mar. 16, 2022 (KR) 10-2022-0032930

(51) Int. Cl. H04W 74/0816; H04L 1/1607; H04W 74/00

(52) U.S. Cl. CPC H04W 74/0816; H04L 1/1614; H04W 74/002

(57) ABSTRACT

Disclosed are a method and device for direct communication in a wireless LAN supporting EMLSR. A method of a first STA comprises the steps of: generating a first frame including a first field including the address of a second STA that is a target of direction communication; transmitting the first frame to an AP; and transmitting a data frame to the second STA when it is determined that the second STA operates in an EMLSR operation state at the request of the AP, wherein the second STA is an EMLSR STA and operates in the EMLSR operation state or a listen operation state.

### TECHNICAL FIELD

The present disclosure relates to a wireless local area network (LAN) communication technique, and more particularly, to a direction communication technique for an enhanced multi-link signal radio (EMLSR) station (STA).

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

However, since a multi-link operation is an operation not defined in the existing wireless LAN standard, it may be necessary to define detailed operations according to an environment in which the multi-link operation is performed. In particular, a device (e.g., station (STA)) supporting enhanced multi-link single radio (EMLSR) operations may wait for reception in a multi-link. The device supporting EMLSR operations may be referred to as an EMLSR device. When a specific control frame is received from an AP, the EMLSR device may start a reception procedure. In other words, since operations of the EMLSR device are controlled by the AP, the EMLSR device may not be able to efficiently perform direct communication. A direct communication method considering the operation characteristics of the EMLSR device is required.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for direction communication in a wireless LAN supporting enhanced multi-link signal radio (EMLSR).

### Technical Solution

A method of a first station (STA), according to a first exemplary embodiment of the present disclosure for achieving the above-described objective, may comprise: generating a first frame including a first field including an address of a second STA that is a target of direct communication; transmitting the first frame to an access point (AP); and in response to determining that the second STA is operating in an enhanced multi-link single radio (EMLSR) operation state, transmitting a data frame to the second STA at a request of the AP, wherein the second STA is an EMLSR STA, and the second STA operates in the EMLSR operation state or a listening operation state.

The first frame may request the AP to transmit an initial control frame to the second STA.

The method may further comprise: receiving a multi-user (MU)-request-to-send (RTS) frame from the AP after transmitting the first frame; and transmitting a clear-to-send (CTS) frame to the AP in response to the MU-RTS frame, wherein when the MU-RTS frame is received, the second STA is determined as operating in the EMLSR operation state, and the data frame is transmitted after transmission of the CTS frame.

The MU-RTS frame may include information indicating sharing of a transmission opportunity (TXP) initiated by the AP, and the data frame may be transmitted within the TXOP shared by the AP.

The first field further may include a first bit indicating an interpretation scheme of an information element included in the first field, the information element may be interpreted as an address of the second STA when the first bit is set to a first value, and the information element may be interpreted as an assisted AP link ID bitmap when the first bit is set to a second value.

The first field may further include an indicator indicating an interpretation scheme of an information element included in the first field, the information element may be interpreted as an association identifier (AID) that is an address of the second STA when the indicator is set to a first value, the information element may be interpreted as high-order bits of a medium access control (MAC) address that is an address of the second STA when the indicator is set to a second value, the information element may be interpreted as low-order bits of a MAC address that is an address of the second STA when the indicator is set to a third value, and the information element may be interpreted as an assisted AP link ID bitmap when the indicator is set to a fourth value.

The first frame may be a quality-of-service (QoS) null frame, the first field may be an AP assistance requested (AAR) control field, and an address of the second STA may be an AID, high-order bits of a MAC address, or low-order bits of a MAC address.

A method of an access point (AP), according to a second exemplary embodiment of the present disclosure for achieving the above-described objective, may comprise: receiving a first frame from a first station (STA); identifying an address of a second STA that is a target of direct communication with the first STA based on a first field included in the first frame; and transmitting an initial control frame to the second STA, wherein the second STA is an enhanced multi-link single radio (EMLSR) STA, and the second STA operates in an EMLSR operation state or a listening operation state.

The method may further comprise: transmitting a multi-user (MU)-request-to-send (RTS) frame including information indicating sharing of a transmission opportunity (TXOP) initiated by the AP to the first STA; and receiving a clear-to-send (CTS) frame from the first STA in response to the MU-RTS frame, wherein the direct communication between the first STA and the second STA is performed within the TXOP shared by the AP.

The first frame may request the AP to transmit the initial control frame to the second STA.

The first field further may include a first bit indicating an interpretation scheme of an information element included in the first field, the information element may be interpreted as an address of the second STA when the first bit is set to a first value, and the information element may be interpreted as an assisted AP link ID bitmap when the first bit is set to a second value.

The first field may further include an indicator indicating an interpretation scheme of an information element included in the first field, the information element may be interpreted as an association identifier (AID) that is an address of the second STA when the indicator is set to a first value, the information element may be interpreted as high-order bits of a medium access control (MAC) address that is an address of the second STA when the indicator is set to a second value, the information element may be interpreted as low-order bits of a MAC address that is an address of the second STA when the indicator is set to a third value, and the information element may be interpreted as an assisted AP link ID bitmap when the indicator is set to a fourth value.

The first frame may be a quality-of-service (QoS) null frame, the first field may be an AP assistance requested (AAR) control field, and an address of the second STA may be an AID, high-order bits of a MAC address, or low-order bits of a MAC address.

A first station (STA), according to a third exemplary embodiment of the present disclosure for achieving the above-described objective, may comprise a processor, and the processor may cause the first STA to perform: generating a first frame including a first field including an address of a second STA that is a target of direct communication; transmitting the first frame to an access point (AP); and in response to determining that the second STA is operating in an enhanced multi-link single radio (EMLSR) operation state, transmitting a data frame to the second STA at a request of the AP, wherein the second STA is an EMLSR STA, and the second STA operates in the EMLSR operation state or a listening operation state.

The first frame may request the AP to transmit an initial control frame to the second STA.

The processor may further cause the first STA to perform: receiving a multi-user (MU)-request-to-send (RTS) frame from the AP after transmitting the first frame; and transmitting a clear-to-send (CTS) frame to the AP in response to the MU-RTS frame, wherein when the MU-RTS frame is received, the second STA is determined as operating in the EMLSR operation state, and the data frame is transmitted after transmission of the CTS frame.

The MU-RTS frame may include information indicating sharing of a transmission opportunity (TXP) initiated by the AP, and the data frame may be transmitted within the TXOP shared by the AP.

The first field further may include a first bit indicating an interpretation scheme of an information element included in the first field, the information element may be interpreted as an address of the second STA when the first bit is set to a first value, and the information element may be interpreted as an assisted AP link ID bitmap when the first bit is set to a second value.

The first field may further include an indicator indicating an interpretation scheme of an information element included in the first field, the information element may be interpreted as an association identifier (AID) that is an address of the second STA when the indicator is set to a first value, the information element may be interpreted as high-order bits of a medium access control (MAC) address that is an address of the second STA when the indicator is set to a second value, the information element may be interpreted as low-order bits of a MAC address that is an address of the second STA when the indicator is set to a third value, and the information element may be interpreted as an assisted AP link ID bitmap when the indicator is set to a fourth value.

The first frame may be a quality-of-service (QoS) null frame, the first field may be an AP assistance requested (AAR) control field, and an address of the second STA may be an AID, high-order bits of a MAC address, or low-order bits of a MAC address.

### Advantageous Effects

According to the present disclosure, an EMLSR device may wait for reception of a frame in links corresponding to the number of antennas. When a specific control frame (e.g., initial control frame) is received from an AP or STA, the EMLSR device can switch a radio chain to a link in which the specific control frame is received, and can quickly perform communication (e.g., direct communication) with the STA in the link by using a plurality of spatial streams. The AP may share a communication period for direct communication with the STA and/or EMLSR device. In this case, the direct communication between the STA and EMLSR device can be quickly performed within the communication period shared by the AP.

Accordingly, the performance of the wireless LAN can be improved.

### DESCRIPTION OF DRAWINGS

FIG. 1 is a conceptual diagram illustrating a first exemplary embodiment of a wireless LAN system.

FIG. 2 is a block diagram illustrating a first exemplary embodiment of a communication node constituting a wireless LAN system.

FIG. 3 is a conceptual diagram illustrating a first exemplary embodiment of a multi-link configured between multi-link devices (MLDs).

FIG. 4 is a sequence chart illustrating an association procedure of a station in a wireless LAN system.

FIG. 5 is a timing diagram illustrating a first exemplary embodiment of an operation method of a communication node based on EDCA.

FIG. 6 is a block diagram illustrating a first exemplary embodiment of an enhanced multi-link single radio (EMLSR) device in a wireless LAN.

FIG. 7 is a timing diagram illustrating a first exemplary embodiment of a direct communication method for an EMLSR STA.

FIG. 8 is a timing diagram illustrating a second exemplary embodiment of a direct communication method for an EMLSR STA.

FIG. 9 is a timing diagram illustrating a third exemplary embodiment of a direct communication method for an EMLSR STA.

FIG. 10 is a timing diagram illustrating a fourth exemplary embodiment of a direct communication method for an EMLSR STA.

FIG. 11 is a timing diagram illustrating a fifth exemplary embodiment of a direct communication method for an EMLSR STA.

FIG. 12 is a timing diagram illustrating a sixth exemplary embodiment of a direct communication method for an EMLSR STA.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

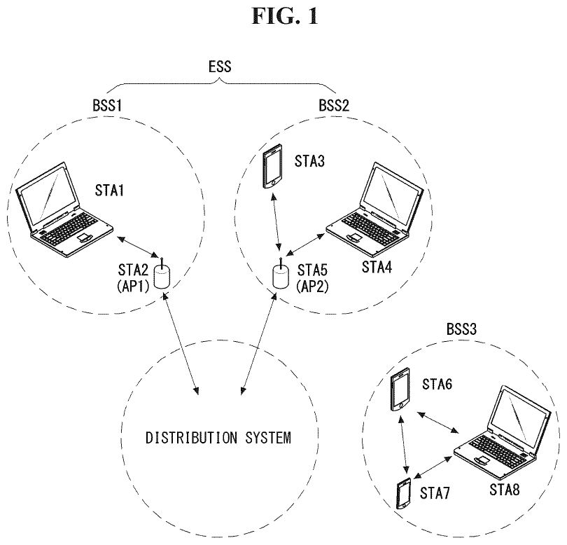

FIG. 1 is a conceptual diagram illustrating a first exemplary embodiment of a wireless LAN system.

Referring to FIG. 1, a wireless LAN system may include at least one basic service set (BSS). A BSS may refer to a set of stations (e.g., STA1, STA2 (AP1), STA3, STA4, STA5 (AP2), STA6, STA7, and STA8) that can communicate with each other through successful synchronization, and may not refer to a specific region. In exemplary embodiments below, a station performing functions as an access point may be referred to as an ‘access point (AP)’, and a station not performing functions as an access point may be referred to as a ‘non-AP station’ or a ‘station’.

The BSS may be classified into an infrastructure BSS and an independent BSS (IBSS). Here, a BSS1 and a BSS2 may mean infrastructure BSSs, and a BSS3 may mean an IBSS. The BSS1 may include a first station (STA1), a first access point (STA2 (AP1)) providing a distribution service, and a distribution system (DS) connecting a plurality of access points (STA2 (AP1) and STA5 (AP2)). In the BSS1, the first access point STA2 (AP1) may manage the first station STA1.

The BSS2 may include a third station (STA3), a fourth station (STA4), a second access point (STA5 (AP2)) providing a distribution service, and a DS connecting the plurality of access points (STA2 (AP1) and STA5 (AP2)). In the BSS2, the second access point STA5 (AP2) may manage the third station STA3 and the fourth station STA4.

The BSS3 may mean an IBSS operating in an ad-hoc mode. An access point, which is a centralized management entity, may not exist in the BSS3. That is, in the BSS3, the stations STA6, STA7, and STA8 may be managed in a distributed manner. In the BSS3, all stations STA6, STA7, and STA8 may refer to mobile stations, and since they are not allowed to access a DS, they may constitute a self-contained network.

The access points STA2 (AP1) and STA5 (AP2) may provide access to the DS for the stations STA1, STA3, and STA4 associated therewith via a wireless medium. In the BSS1 or BSS2, communications between the stations STA1, STA3, and STA4 are generally performed through the access points STA2 (AP1) and STA5 (AP2), but when direct links are established, direct communications between the stations STA1, STA3, and STA4 may be possible.

A plurality of infrastructure BSSs may be interconnected through a DS. The plurality of BSSs connected through the DS may be referred to as an extended service set (ESS). The communication nodes STA1, STA2 (AP1), STA3, STA4, and STA5 (AP2) included in the ESS may communicate with each other, and an arbitrary station (STA1, STA3, or STA4) may move from one BSS to another BSS within the same ESS while communicating without interruption.

The DS may be a mechanism for one access point to communicate with another access point, according to which an access point may transmit frames for stations associated with the BSS it manages, or transmit frames for an arbitrary station that has moved to another BSS. Also, the access point may transmit and receive frames to and from an external network such as a wired network. Such the DS may not necessarily have to be a network, and if it can provide a predetermined distribution service stipulated in the IEEE 802.11 standard, there is no restriction on its form. For example, the DS may be a wireless network such as a mesh network or a physical structure that connects the access points to each other. The communication nodes STA1, STA2 (AP1), STA3, STA4, STA5 (AP2), STA6, STA7, and STA8 included in the wireless LAN system may be configured as follows.

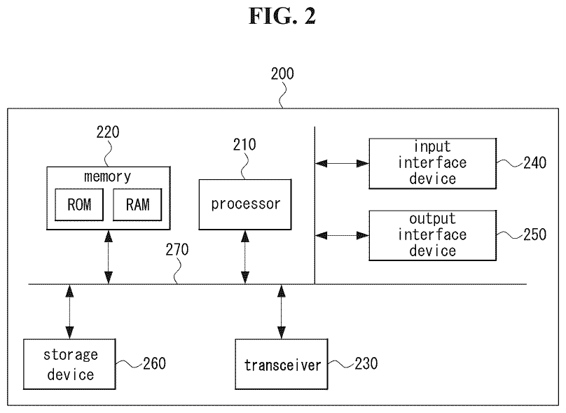

FIG. 2 is a block diagram illustrating a first exemplary embodiment of a communication node constituting a wireless LAN system.

Referring to FIG. 2, a communication node 200 may include at least one processor 210, a memory 220, and a transceiver 230 connected to a network to perform communications. The transceiver 230 may be referred to as a transceiver, a radio frequency (RF) unit, an RF module, or the like. In addition, the communication node 200 may further include an input interface device 240, an output interface device 250, a storage device 260, and the like. The respective components included in the communication node 200 may be connected by a bus 270 to communicate with each other.

However, the respective components included in the communication node 200 may be connected through individual interfaces or individual buses centering on the processor 210 instead of the common bus 270. For example, the processor 210 may be connected to at least one of the memory 220, the transceiver 230, the input interface device 240, the output interface device 250, and the storage device 260 through a dedicated interface.

The processor 210 may execute program commands stored in at least one of the memory 220 and the storage device 260. The processor 210 may refer to a central processing unit (CPU), a graphics processing unit (GPU), or a dedicated processor on which the methods according to the exemplary embodiments of the present invention are performed. Each of the memory 220 and the storage device 260 may be configured as at least one of a volatile storage medium and a nonvolatile storage medium. For example, the memory 220 may be configured with at least one of a read only memory (ROM) and a random access memory (RAM).

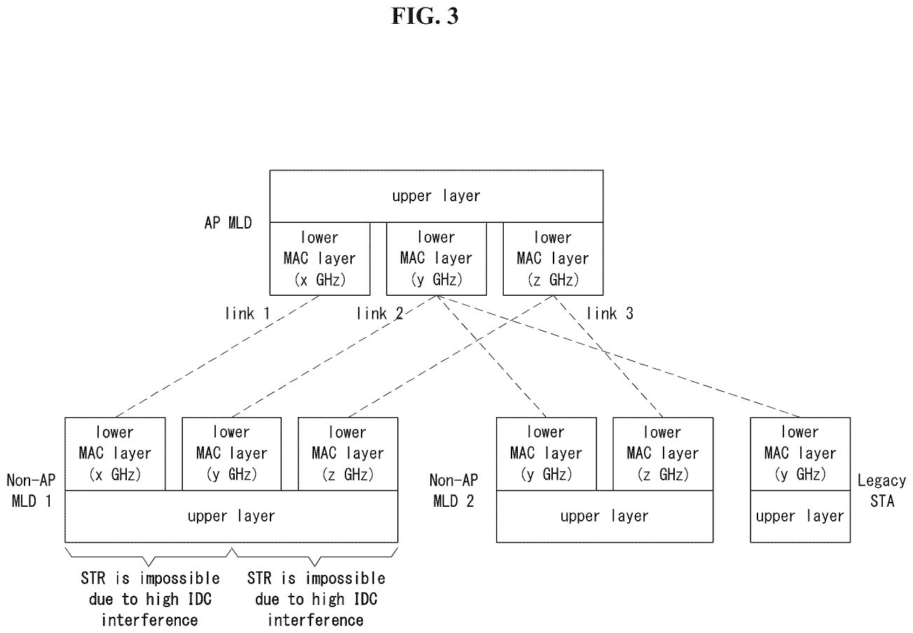

FIG. 3 is a conceptual diagram illustrating a first exemplary embodiment of a multi-link configured between multi-link devices (MLDs).

Referring to FIG. 3, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD). The AP of the AP MLD may mean an AP affiliated with the AP MLD. The STA of the STA MLD may mean a STA affiliated with the STA MLD.

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 210 shown in FIG. 2). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 210 shown in FIG. 2).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

Each of the AP MLD and the STA MLD may have an MLD MAC address, and each of the AP and the STA operating in each link may have a MAC address. The MLD MAC address of the AP MLD may be referred to as an AP MLD MAC address, and the MLD MAC address of the STA MLD may be referred to as a STA MLD MAC address. The MAC address of the AP may be referred to as an AP MAC address, and the MAC address of the STA may be referred to as a STA MAC address. In a multi-link negotiation procedure, the AP MLD MAC address and the STA MLD MAC address may be used. The address of the AP and the address of the STA may be exchanged and/or configured in the multi-link negotiation procedure.

When the multi-link negotiation procedure is completed, the AP MLD may generate an address table and manage and/or update the address table. One AP MLD MAC address may be mapped to one or more AP MAC addresses, and corresponding mapping information may be included in the address table. One STA MLD MAC address may be mapped to one or more STA MAC addresses, and corresponding mapping information may be included in the address table. The AP MLD may identify address information based on the address table. For example, when a STA MLD MAC address is received, the AP MLD may identify one or more STA MAC addresses mapped to the STA MLD MAC address based on the address table.

In addition, the STA MLD may manage and/or update the address table. The address table may include ‘mapping information between the AP MLD MAC address and the AP MAC address(es)’ and/or ‘mapping information between the STA MLD MAC address and the STA MAC address(es)’. The AP MLD may receive a packet from a network, identify an address of a STA MLD included in the packet, identify link(s) supported by the STA MLD, and may identify STA(s) taking charge of the link(s) from the address table. The AP MLD may set STA MAC address(es) of the identified STA(s) as a receiver address(es), and may generate and transmit frame(s) including the receiver address(es).

Meanwhile, an association procedure in a wireless LAN system may be performed as follows.

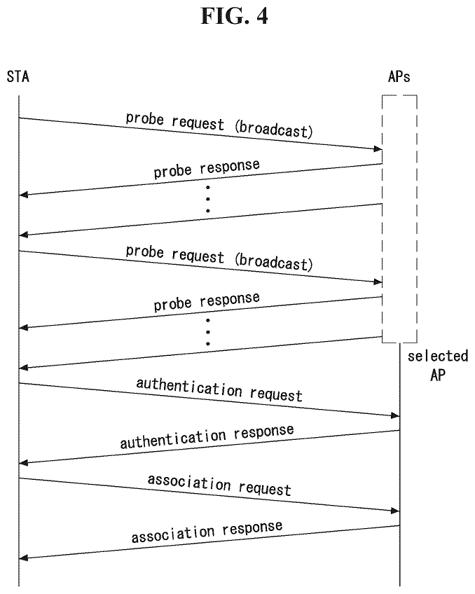

FIG. 4 is a sequence chart illustrating an association procedure of a station in a wireless LAN system.

Referring to FIG. 4, an association procedure of a STA in an infrastructure BSS may generally be divided into a probe step of detecting AP(s), an authentication step with detected AP(s), and an association step with the authenticated AP(s). The STA may be a STA MLD or a STA affiliated with the STA MLD, and the AP may be an AP MLD or an AP affiliated with the AP MLD.

The STA may detect neighboring APs using a passive scanning scheme or an active scanning scheme. When the passive scanning scheme is used, the STA may detect neighboring APs by overhearing beacons transmitted by APs. When the active scanning scheme is used, the STA may transmit a probe request frame, and may detect neighboring APs by receiving probe response frames that are responses to the probe request frame from the APs.

When the neighboring APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In this case, the STA may select one AP among AP(s) with which the STA has performed the authentication step, and perform the association step with the selected AP. That is, the STA may transmit an association request frame to the selected AP, and may complete the association with the selected AP by receiving an association response frame that is a response to the association request frame from the selected AP.

Meanwhile, communication nodes (e.g., access points, stations, and the like) belonging to the wireless LAN system may perform transmission and reception operations of frames based on a point coordination function (PCF), hybrid coordination function (HCF), HCF controlled channel access (HCCA), distributed coordination function (DCF), enhanced distributed channel access (EDCA), and/or the like.

In the wireless LAN system, frames may be classified into a management frame, a control frame, and a data frame. The management frame may include an association request frame, association response frame, reassociation request frame, reassociation response frame, probe request frame, probe response frame, beacon frame, disassociation frame, authentication frame, deauthentication frame, action frame, and the like.

The control frame may include an acknowledgment (ACK) frame, block ACK request (BAR) frame, block ACK (BA) frame, power saving (PS)-Poll frame, request-to-send (RTS) frame, clear-to-send (CTS) frame, and the like. The data frame may be classified into a quality of service (QoS) data frame and a non-QoS data frame. The QoS data frame may refer to a data frame for which transmission according to a QoS is required, and the non-QoS data frame may indicate a data frame for which transmission according to a QoS is not required. The QoS data frame may include a QoS Null frame, and the QoS Null frame may not include a payload.

Meanwhile, in a wireless LAN system, a communication node (e.g., access point or station) may operate based on the EDCA scheme.

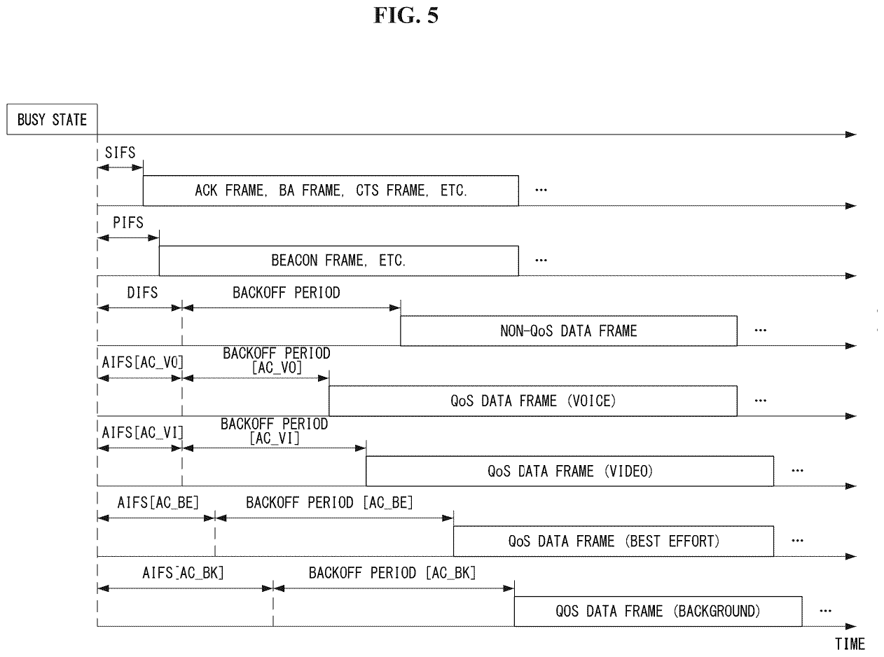

FIG. 5 is a timing diagram illustrating a first exemplary embodiment of an operation method of a communication node based on EDCA.

Referring to FIG. 5, a communication node desiring to transmit a control frame (or a management frame) may perform a channel state monitoring operation (e.g., carrier sensing operation) during a predetermined period (e.g., short interframe space (SIFS) or PCF IFS (PIFS)), and when the channel state is determined to be idle during the predetermined period (e.g., SIFS or PIFS), the communication node may transmit the control frame (or the management frame). For example, the communication node may transmit an ACK frame, a BA frame, a CTS frame, or the like when the channel state is determined to be idle during SIFS. Also, the communication node may transmit a beacon frame or the like when the channel state is determined to be idle during the PIFS. On the other hand, when it is determined that the channel state is busy during the predetermined period (e.g., SIFS or PIFS), the communication node may not transmit the control frame (or the management frame). Here, the carrier sensing operation may refer to a clear channel assessment (CCA) operation.

A communication node desiring to transmit a non-QoS data frame may perform a channel state monitoring operation (e.g., carrier sensing operation) during DCF IFS (DIFS), and when the channel state is determined to be idle during the DIFS, the communication node may perform a random backoff procedure. For example, the communication node may select a backoff value (e.g., a backoff counter) within a contention window according to the random backoff procedure and may perform a channel state monitoring operation (e.g., carrier sensing operation) during a period corresponding to the selected backoff value (hereinafter, referred to as ‘backoff period’). The communication node may transmit the non-QoS data frame when the channel state is determined to be idle in the backoff period.

A communication node desiring to transmit a QoS data frame may perform a channel state monitoring operation (e.g., carrier sensing operation) during an arbitration IFS (AIFS), and when the channel state is determined to be idle during the AIFS, the communication node may perform a random backoff procedure. The AIFS may be configured according to an access category (AC) of a data unit (e.g., protocol data unit (PDU)) included in the QoS data frame. The AC of the data unit may be as shown in Table 1 below.

TABLE 1

| Priority | AC | Description |
|---|---|---|
| Lowest | AC_BK | Background |
| | AC_BE | Best effort |
| | AC_VI | Video |
| Highest | AC_VO | Voice |

AC_BK may indicate background data, AC_BE may indicate data transmitted in the best effort manner, AC_VI may indicate video data, AC_VO may indicate voice data. For example, the length of the AIFS for the QoS data frame corresponding to each of AC_VO and AC_VI may be configured to be equal to the length of the DIFS. The length of the AIFS for the QoS data frame corresponding to each of AC_BE and AC_BK may be configured to be longer than the length of the DIFS. Here, the length of the AIFS for the QoS data frame corresponding to AC_BK may be configured to be longer than the length of the AIFS for the QoS data frame corresponding to AC_BE.

In the random backoff procedure, the communication node may select a backoff value (e.g., a backoff counter) within a contention window according to the AC of the QoS data frame. The contention window according to the AC may be as shown in Table 2 below. CW min may indicate a minimum value of the contention window, CWₘₐₓ may indicate a maximum value of the contention window, and each of the minimum value and the maximum value of the contention window may be represented by the number of slots.

TABLE 2

| AC | CWₘᵢₙ | CWₘₐₓ |
|---|---|---|
| AC_BK | 31 | 1023 |
| AC_BE | 31 | 1023 |
| AC_VI | 15 | 31 |
| AC_VO | 7 | 15 |

The communication node may perform a channel state monitoring operation (e.g., carrier sensing operation) in the backoff period and may transmit the QoS data frame when the channel state is determined to be idle in the backoff period.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP.

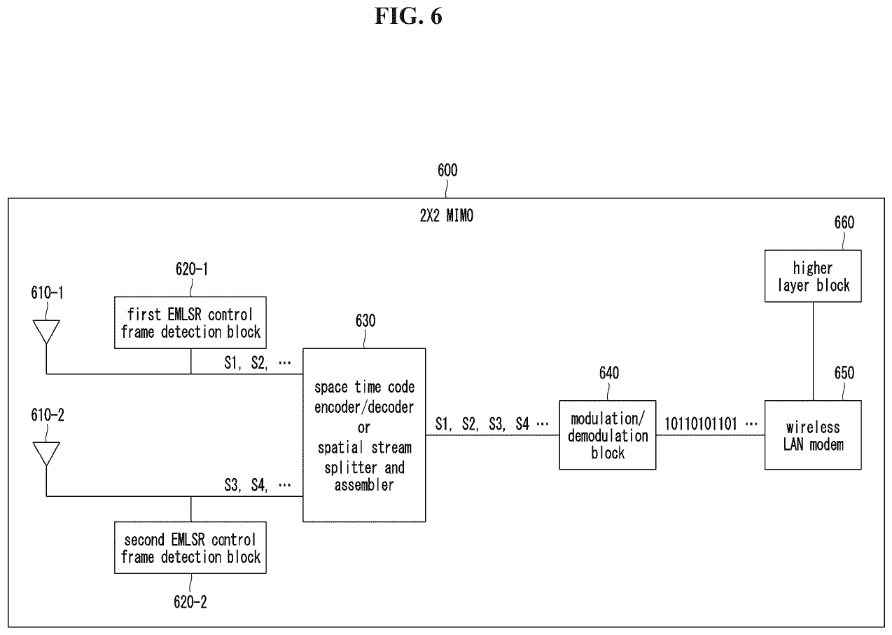

FIG. 6 is a block diagram illustrating a first exemplary embodiment of an enhanced multi-link single radio (EMLSR) device in a wireless LAN.

Referring to FIG. 6, an EMLSR device 600 may be an MLD supporting MLSR operations and/or EMLSR operations. The EMLSR device 600 may be referred to as an MLSR device. An EMLSR STA (or MLSR STA) may be a STA supporting MLSR operations and/or EMLSR operations, and an EMLSR AP (or MLSR AP) may be an AP supporting MLSR operations and/or EMLSR operations. The MLSR operation may mean an MLSR mode, and the EMLSR operation may mean an EMLSR mode. The EMLSR device 600 may include antennas 610-1 and 610-2, EMLSR control message detection blocks 620-1 and 620-2, a spatial stream processing block 630, a modulation and demodulation block 640, a wireless LAN modem 650, and/or a higher layer block 660. In exemplary embodiments, a spatial stream may be referred to as ‘SS’.

The EMLSR device 600 may include the plurality of antennas 610-1 and 610-2. The first antenna 610-1 may be used for a sensing operation and/or a reception operation of signals in a first link. The second antenna 610-2 may be used for a sensing operation and/or a reception operation of signals in a second link. A frequency at which the first link operates may be different from a frequency at which the second link operates. The sensing operation and/or reception operation performed by the first antenna and/or the second antenna may be referred to as ‘listening operation’. In order to simultaneously receive spatial stream signals, the first antenna 610-1 and the second antenna 610-2 may perform sensing operations and/or reception operations of signals in one of the first link and the second link. Among the plurality of antennas 610-1 and 610-2 included in the EMLSR device 600, one antenna may be a primary antenna, and the remaining antenna(s) may be secondary antenna(s). The primary antenna and secondary antenna(s) may be configured in advance. Alternatively, the primary antenna and the secondary antenna(s) may be configured in a negotiation procedure between the EMLSR device 600 and another device (e.g., AP MLD supporting EMLSR operations). An antenna performing a listening operation in a link having a low number (e.g., low index) may be configured as the primary antenna, and the remaining antenna(s) may be configured as the secondary antenna(s).

The first EMLSR control frame detection block 620-1 may be connected to or cooperate with the first antenna 610-1, and the second EMLSR control frame detection block 620-2 may be connected to or cooperate with the second antenna 610-2. Electromagnetic waves (e.g., signals) detected by the antennas 610-1 and 610-2 may be input to the EMLSR control frame detection blocks 620-1 and 620-2. The EMLSR control frame detection blocks 620-1 and 620-2 may determine whether the electromagnetic wave (e.g., signal) corresponds to a specific control frame (e.g., initial control frame). The EMLSR control frame detection blocks 620-1 and 620-2 may support only a predefined modulation and coding scheme (MCS) and may identify only predefined control frame formats. The formats of the predefined control frames (e.g., specific control frame, initial control frame) may include a request-to-send (RTS) frame, a multi-user (MU)-RTS trigger frame, and/or a buffer status report poll (BSRP) trigger frame.

When a specific control frame is detected in the EMLSR control frame detection blocks 620-1 and 620-2, the EMLSR device 600 may perform a reception operation for simultaneously receiving data through multiple streams by using as many spatial streams as the number of spatial streams (e.g., the number of antennas) supported by the EMLSR device 600. In order to perform the reception operation for receiving multiple spatial streams at the same time, a clear-to-send (CTS) frame may be transmitted through the first antenna 610-1 after a short inter-frame space (SIFS) from a time of detecting the specific control frame in the first link, and the second antenna 610-2 operating in the second link in which the specific control frame is not detected may switch to the first link and operate in the first link. In other words, a reception (RX) radio chain may be switched to operate in the first link. The RX radio chain may refer to a radio chain in the present disclosure. In addition, the radio chain may refer to a reception radio chain or a reception chain in the present disclosure. A radio chain may refer to a radio frequency (RF) chain. Switching of an operating link of the second antenna 610-2 (e.g., switching of the radio chain) may start after the time of detecting the specific control frame in the first link, and may be completed until a SIFS elapses after transmitting the CTS signal after a SIFS elapses. The multiple spatial streams (e.g., two spatial streams) may then be received through the plurality of antennas 610-1 and 610-2. The operation of receiving the MU-RTS trigger frame and switching the radio chain to receive the multiple spatial streams may be referred to as ‘EMLSR operation’.

When the specific control frame is detected by the EMLSR control frame detection blocks 620-1 and 620-2, and the reception procedure for the multiple spatial streams is performed, the spatial stream processing block 630 may perform a rearrangement operation for signals (e.g., symbols) received through the plurality of antennas 610-1 and 610-2. When a space time code is used, a single symbol may be generated into a plurality of symbols by a coding operation, and the plurality of symbols may be transmitted. The space time code may be an Alamouti code. The spatial stream processing block 630 may perform an operation of restoring the redundant symbols into the single symbol in a decoding procedure.

The output symbols of the spatial stream processing block 630 may be input to the modulation/demodulation block 640. The modulation/demodulation block 640 may generate bits by performing a demodulation operation on the symbols. The modulation/demodulation block 640 may perform a channel coding operation and/or a channel decoding operation. The output bits of the modulation/demodulation block 640 may be delivered to the wireless LAN modem 650. The wireless LAN modem 650 may perform medium access control (MAC) operations defined in the IEEE 802.11 standards. An output of the wireless LAN modem 650 may be delivered to the higher layer block 660. The higher layer block 660 may perform higher layer operations defined in the IEEE 802.11 standards. A series of operations performed after the specific control frame is detected by the EMLSR control frame detection block may be operations performed during the EMLSR operation. In the EMLSR device 600, a transmission operation may be performed in the reverse order of the above-described reception operation. The above-described antenna may refer to an RF chain that is a transmission and reception block including the antenna. The RF chain may be a hardware or/and logical structure including both a transmission (Tx) chain and an reception (Rx) chain.

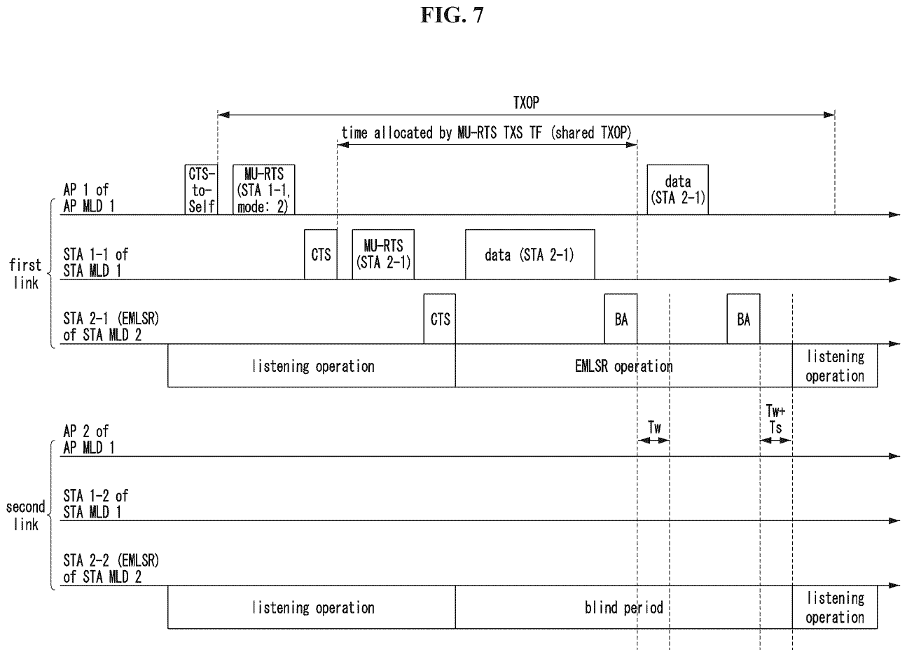

FIG. 7 is a timing diagram illustrating a first exemplary embodiment of a direct communication method for an EMLSR STA.

Referring to FIG. 7, an AP 1 may configure a transmission opportunity (TXOP) in a first link by transmitting a CTS-to-Self frame in the first link. Alternatively, the AP 1 may configure a TXOP based on transmission of an RTS frame, reception of a CTS frame, transmission of a data frame, and/or transmission of a trigger frame including a MU-RTS trigger frame in the first link. Alternatively, when an enhanced distributed channel access function (EDCAF) of the AP 1 determines transmission as a result of channel contention, the AP 1 may obtain a TXOP. In other words, the AP 1 may be a holder of the TXOP configured in the first link. After configuring the TXOP, the AP 1 may initiate a TXOP sharing procedure for a STA 1-1 by transmitting an MU-RTS frame to the STA 1-1 in the first link. The MU-RTS frame transmitted by the AP 1 to the STA 1-1 may be an MU-RTS TXOP sharing frame (e.g., MU-RTS TXOP sharing (TXS) trigger frame). A sharing mode field included in a common information field of the MU-RTS frame transmitted by the AP 1 to initiate the TXOP sharing procedure for the STA 1-1 may be set to 2. In other words, the sharing mode field may indicate a sharing mode 2. The sharing mode 2 may indicate that the MU-RTS frame including the sharing mode field initiates the TXOP sharing procedure. The sharing mode 2 may mean that the following operations are performed.

The MU-RTS frame may initiate the TXOP sharing procedure (e.g., MU-RTS TXOP sharing procedure). In the TXOP sharing procedure, a STA may transmit a physical layer protocol data unit (PPDU) to an AP with which the STA is associated or another STA. When the MU-RTS frame of the AP 1 is received, the STA 1-1 may transmit a CTS frame to the AP 1 in response to the MU-RTS frame. The AP 1 may receive the CTS frame from the STA 1-1.

A peer-to-peer (P2P) setup procedure may be performed between a STA MLD 1 and a STA MLD 2. The P2P setup procedure may refer to a tunneled direct link setup (TDLS) procedure. In the P2P setup procedure, capability information of the STA MLD 1 and/or capability information of the STA MLD 2 may be exchanged. For example, the STA MLD 1 may receive the capability information of the STA MLD 2, and the STA MLD 2 may receive the capability information of the STA MLD 1. In addition, the STA MLD 1 may identify an association identifier (AID) of the STA MLD 2 in the P2P setup procedure, and the STA MLD 2 may identify an AID of the STA MLD 1 in the P2P setup procedure. The STA MLD 1 may identify that the STA MLD 2 is an EMLSR MLD. In other words, the STA MLD 1 may identify that the STA MLD 2 performs EMLSR operations. Each of a STA 2-1 and a STA 2-2 affiliated with the STA MLD 2 may be an EMLSR STA.

Transmission of an MU-RTS frame (e.g., MU-RTS trigger frame) may be allowed in order for the STA 1-1 to transmit data (e.g., P2P data or direct communication data) to the STA 2-1 (e.g., EMLSR STA). In the present disclosure, the MU-RTS frame may mean an MU-RTS trigger frame. The trigger frame (e.g., MU-RTS trigger frame, BSRP trigger frame) may be used by the AP to trigger transmission to a plurality of STAs. In other words, transmission of a trigger frame may be performed only by the AP. However, when a trigger frame serves as an initial control frame for initiating communication (e.g., direct communication) with the EMLSR STA, the STA may be allowed to transmit the trigger frame. In the present disclosure, the MU-RTS frame may be used as an initial control frame.

The STA 1-1 may transmit an MU-RTS frame to the EMLSR STA 2-1. The MU-RTS frame of the STA 1-1 may be transmitted considering a switching time Ts of a radio chain for EMLSR operations of the STA MLD 2. The STA 1-1 may add padding bit(s) corresponding to the switching time Ts of the radio chain of the STA 2-1 to the MU-RTS frame (e.g., padding field of the MU-RTS frame). When the STA 1-1 does not know the switching time of the radio chain of the STA MLD 2 (e.g., STA 2-1), the STA 1-1 may add padding bit(s) corresponding to the maximum switching time of the radio chain to the MU-RTS frame (e.g., padding field of the MU-RTS frame).

The STA 2-1 may receive the MU-RTS frame from the STA 1-1. In this case, the STA MLD 2 may transition an operation state of the STA 2-1 in the first link from a listening operation state to a normal operation state. In other words, the STA MLD 2 (e.g., EMLSR MLD, EMLSR STA MLD) may perform an antenna switching operation so that an antenna performing a listening operation in the second link performs a reception operation in the first link. Operating links of all antenna(s) performing listening operation(s) in other link(s) may be switched to the first link, and a reception operation of multiple spatial streams using a plurality of antennas may be performed in the first link. The operation state capable of receiving multiple spatial streams may be an EMLSR operation state. In the present disclosure, the EMLSR operation state may refer to a normal state, a normal operation state, or a normal reception state.

The STA 2-1 may transmit a CTS frame in response to the MU-RTS frame of the STA 1-1. The STA 2-1 may operate in the EMLSR operation state after a SIFS from the transmission time of the CTS frame. When the CTS frame of the STA 2-1 is received, the STA 1-1 may determine that the STA 2-1 is operating in the EMLSR operation state. When the CTS frame of the STA 2-1 is received and/or when it is determined that the STA 2-1 is in the EMLSR operation state, the STA 1-1 may transmit a data frame to the STA 2-1. The STA 2-1 may receive the data frame from the STA 1-1 and may transmit a response frame to the STA 1-1 in response to the data frame. The STA 1-1 may receive the response frame from the STA 2-1. In the present disclosure, the response frame may be an acknowledgment (ACK) frame or a block ACK (BA) frame. In the present disclosure, a transmission time of a frame may mean a transmission start time or transmission end time thereof, and a reception time of a frame may mean a reception start time or reception end time thereof.

While the EMLSR MLD (e.g., STA MLD 2, STA 2-1) operates in the EMLSR operation state in the first link, a clear channel assessment (CCA) operation cannot be performed in other link(s), and a network allocation vector (NAV)) cannot be set in other link(s). In other words, other link(s) may be in a blindness state in which the CCA operation and NAV setting operation cannot be performed. A period in the blindness state may be referred to as ‘blind period’.

When the reception of the data frame of the STA 1-1 is completed, the STA MLD 2 may transition the operation state of the STA 2-1 from the EMLSR operation state to the listening operation state after a time Tw elapses from a reception completion time of the data frame in the first link. The time Tw may be (aSIFSTime (16 us)+aSlotTime (9 us)+aRxPHYStartDelay time). If communication is not performed during a PIFS, the AP 1 may terminate sharing of the TXOP. The PIFS may be (aSIFSTime (16 us)+aSlotTime (9 us)). A time required for the AP 1 to terminate sharing of the TXOP be more than the time Tw. Alternatively, the AP 1 may terminate sharing of the TXOP when an RDG/MorePPDU field included in a MAC header of a frame transmitted by the STA 1-1 is set to 0.

Before the STA MLD 2 transitions the operation state of the STA 2-1 from the EMLSR operation state to the listening operation state (e.g., from a time of exchanging the last frame within the shared TXOP to an expiration of the time Tw), the AP 1 may initiate transmission of a data frame for the STA 2-1. When the STA 2-1 receives a PPDU (e.g., data frame) during the time Tw, a physical layer of the STA 2-1 may transmit a PHY-RXSTART.indication, which is a primitive, to a MAC layer of the STA 2-1. When the MAC layer of the STA 2-1 receives the PHY-RXSTART.indication, the operation state of the STA 2-1 may not transition from the EMLSR operation state to the listening operation state. The STA 2-1 not performing a listening operation may receive a data frame of the AP 1 without receiving an initial control frame (e.g., MU-RTS frame). The STA 2-1 may transmit a response frame to the data frame of the AP 1 to the AP 1.

If the MAC layer of the STA 2-1, which has transmitted the response frame for the data frame, does not receive the PHY-RXSTART.indication from the physical layer during the time Tw, the STA 2-1 may transition its operation state from the EMLSR operation state to the listening operation state. For the transition between the EMLSR operation state and the listening operation state, a switching time Ts of a radio chain may be required in the EMLSR STA (e.g., STA 2-1). The switching time of the radio chain may refer to a link switching time. The STA 2-1 affiliated with the STA MLD 2 may operate in the first link, and the STA 2-2 affiliated with the STA MLD 2 may operate in the second link. When the STA 2-1 operates in the listening operation state, the STA 2-2 may operate in the listening operation state in the same manner as the STA 2-1. While the STA 2-1 operates in the EMLSR operation state, the second link in which the STA 2-2 operates may be in the blindness state. In the blindness state, frame transmission and reception operations and/or CCA operations (e.g., channel detection operations) may be impossible.

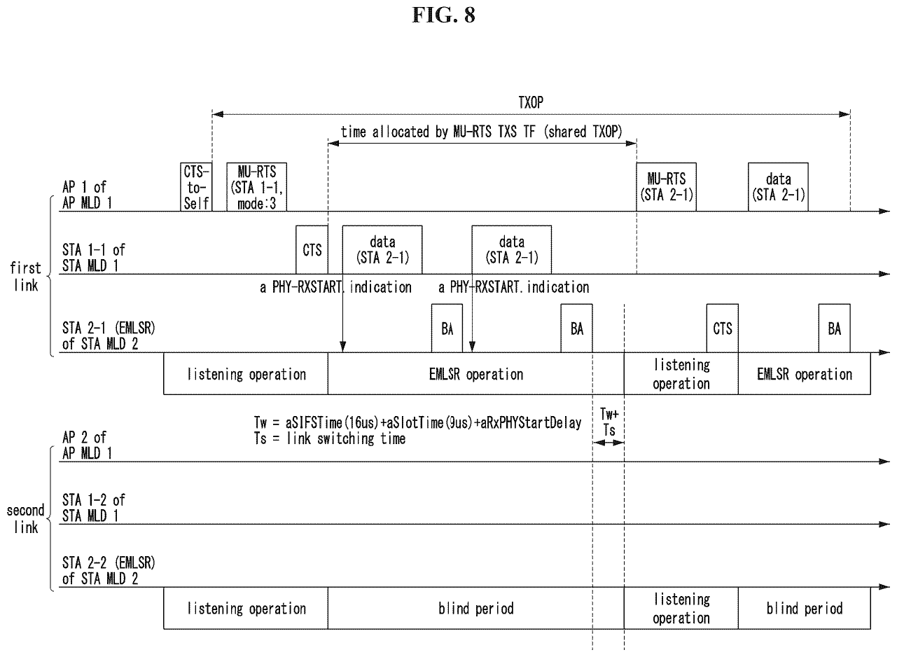

FIG. 8 is a timing diagram illustrating a second exemplary embodiment of a direct communication method for an EMLSR STA.

Referring to FIG. 8, the AP 1 may configure a TXOP in the first link by transmitting a CTS-to-Self frame in the first link. Alternatively, the AP 1 may configure a TXOP based on transmission of an RTS frame, reception of a CTS frame, transmission of a data frame, and/or transmission of a trigger frame including an MU-RTS trigger frame in the first link. Alternatively, when the EDCAF of the AP 1 determines transmission as a result of channel contention, the AP 1 may obtain a TXOP. In other words, the AP 1 may be a holder of the TXOP configured in the first link. After configuring the TXOP, the AP 1 may initiate a TXOP sharing procedure for the STA 1-1 by transmitting an MU-RTS frame to the STA 1-1 in the first link. The MU-RTS frame transmitted by the AP 1 to the STA 1-1 may be an MU-RTS TXOP sharing frame (e.g., MU-RTS TXOP sharing (TXS) trigger frame). A sharing mode field included in a common information field of the MU-RTS frame transmitted by the AP 1 to initiate the TXOP sharing procedure for the STA 1-1 may be set to 3. In other words, the sharing mode field may indicate a sharing mode 3. The sharing mode 3 may mean that the following operations are performed.

The MU-RTS frame may initiate a TXOP sharing procedure (e.g., MU-RTS TXOP sharing procedure) with negotiated peer EMLSR STA(s). This operation may mean that the MU-RTS frame indicates ‘initiation of TXOP sharing’ and ‘transition of the operation state(s) of EMLSR device(s) that performed P2P setup (e.g., TDLS) with the STA 1-1 (e.g., listening operation state→EMLSR operation state). In other words, the MU-RTS frame may simultaneously serve as an MU-RTS TXS trigger frame indicating TXOP sharing and an initial control frame.

After the TDLS procedure between the STA 1-1 and the STA MLD 2 (e.g., STA 2-1 and/or STA 2-2) is completed, the STA MLD 2 may receive the MU-RTS frame including information indicating the sharing mode 3. In this case, the STA MLD 2 may identify an AID indicated by a user information field included in the MU-RTS frame, and based on the AID, it may identify whether the MU-RTS frame is for a STA for which the TDLS procedure has been completed. When the MU-RTS frame is for a STA for which the TDLS procedure has been completed, the STA MLD 2 may transition to the EMLSR operation state if the MU-RTS frame indicates the sharing mode 3.

The AP 1 may add padding bit(s) corresponding to the switching time Ts of the radio chain to a padding field of the MU-RTS frame in consideration of the switching time of the radio chain of the EMLSR STA. When the MU-RTS frame is normally received, the STA 1-1 may transmit a CTS frame to the AP 1 in response to the MU-RTS frame. The AP 1 may receive the CTS frame from the STA 1-1. The P2P setup procedure between the STA 1-1 and the STA 2-1 may be completed, and the STA 2-1 may be an EMLSR STA. The STA 2-1 may transition to the EMLSR operation state and may wait in the EMLSR operation state in the first link. The STA 2-1 (e.g., EMLSR STA) may receive a frame (e.g., CTS frame and/or another frame) after transitioning to the EMLSR operation state.

The physical layer of the STA may transmit a PHY-RXSTART.indication to the MAC layer when a physical layer header is normally decoded regardless of a transmitter address and/or receiver address of the received frame. The MAC layer of the STA 2-1 may receive the PHY-RXSTART.indication, which is a physical layer primitive for the received frame, from the physical layer of the STA 2-1. If the PHY-RXSTART.indication is received in the MAC layer of the EMLSR STA within the time Tw from a completion time of the transmission and reception procedure of the frame, the EMLSR STA may not transition to the listening operation state. The STA 1-1 may transmit a data frame to the STA 2-1 without transmission of an MU-RTS frame after a SIFS from the transmission time of the CTS frame for the AP 1. The STA 2-1 may receive the data frame from the STA 1-1 and may transmit a response frame to the data frame to the STA 1-1.

If the PHY-RXSTART.indication, which is a physical layer primitive, is not received from the MAC layer of the STA 2-1 during the time Tw, the STA 2-1 may transition from the EMLSR operation state to the listening operation state. For the transition of the operation state of the EMLSR STA, the switching time Ts of the radio chain may be required. The transition of the operation state may mean ‘transition from the EMLSR operation state to the listening operation state’ and/or ‘transition from the listening operation state to the EMLSR operation state’.

If no data frame is transmitted or received during a time (Tw+Ts), the STA 2-1 may transition to the listening operation state. After the STA 2-1 transitions to the listening operation state, the AP 1 may desire to transmit a data frame to the STA 2-1. If the TXOP sharing period ends, but the configured TXOP remains, the AP 1 may transmit an initial control frame (e.g., MU-RTS frame) to the STA 2-1 before transmitting the data frame to the STA 2-1. Since the configured TXOP remains, the AP 1 may transmit the initial control frame (e.g., MU-RTS frame) to the STA 2-1 without performing a backoff operation. The STA 2-1 may receive the initial control frame (e.g., MU-RTS frame) from the AP 1 and may transmit a CTS frame to the AP 1 in response to the initial control frame. The AP 1 may receive the CTS frame from the STA 2-1 and may transmit the data frame to the STA 2-1. The STA 2-1 may receive the data frame from the AP 1 and may transmit a response frame to the data frame to the AP 1. The AP 1 may receive the response frame from the STA 2-1.

The STA MLD 2 may operate in multiple links (e.g., first and second links). The STA 2-2 affiliated with the STA MLD 2 may operate in the second link. When the STA 2-1 operates in the listening operation state, the STA 2-2 may operate in the listening operation state in the same manner as the STA 2-1. In the listening operation state, the STA 2-2 may wait for reception of an initial control frame. When the operation state of the STA 2-1 is the EMLSR operation state, the STA 2-2 may be in the blindness state. In the blindness state, frame transmission and reception operations and/or CCA operations (e.g., channel detection operations) may be impossible.

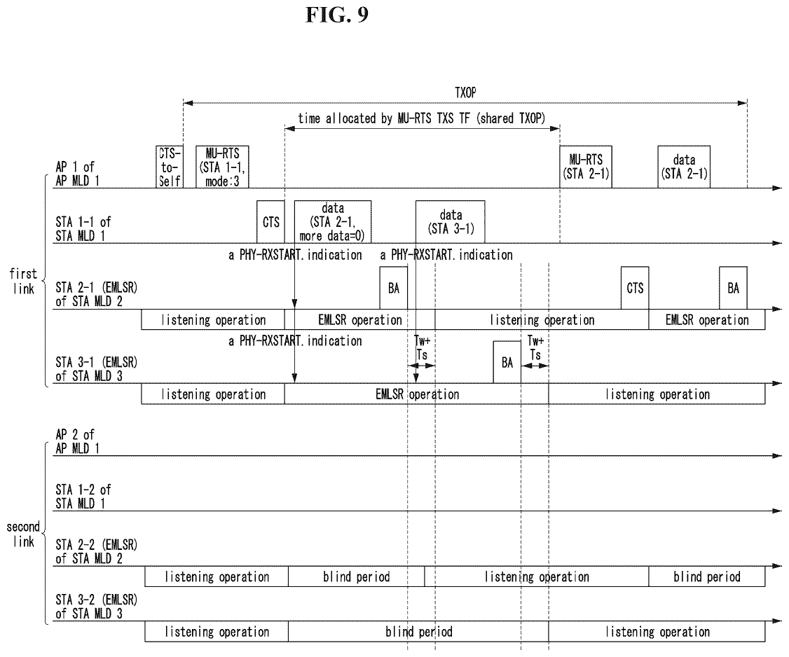

FIG. 9 is a timing diagram illustrating a third exemplary embodiment of a direct communication method for an EMLSR STA.

Referring to FIG. 9, the AP 1 may configure a TXOP in the first link by transmitting a CTS-to-Self frame in the first link. Alternatively, the AP 1 may configure a TXOP based on transmission of an RTS frame, reception of a CTS frame, transmission of a data frame, and/or transmission of a trigger frame including a MU-RTS trigger frame in the first link. Alternatively, when the EDCAF of the AP 1 determines transmission as a result of channel contention, the AP 1 may obtain a TXOP. In other words, the AP 1 may be a holder of the TXOP configured in the first link. After configuring the TXOP, the AP 1 may initiate a TXOP sharing procedure for the STA 1-1 by transmitting an MU-RTS frame to the STA 1-1 in the first link. The MU-RTS frame transmitted by the AP 1 to the STA 1-1 may be an MU-RTS

TXOP sharing frame (e.g., MU-RTS TXOP sharing trigger frame). A sharing mode field included in a common information field of the MU-RTS frame transmitted by the AP 1 to initiate the TXOP sharing procedure for the STA 1-1 may be set to 3. In other words, the sharing mode field may indicate a sharing mode 3. The sharing mode 3 may mean that the following operations are performed.

The MU-RTS frame may initiate a TXOP sharing procedure (e.g., MU-RTS TXOP sharing procedure) with negotiated peer EMLSR STA(s). This operation may mean that the MU-RTS frame indicates ‘initiation of TXOP sharing’ and ‘transition of the operation state(s) of EMLSR device(s) (e.g., STA MLD 2 and/or STA MLD 3) that performed P2P setup (e.g., TDLS) with the STA 1-1 (e.g., listening operation state→EMLSR operation state). In other words, the MU-RTS frame may simultaneously serve as an MU-RTS TXS trigger frame indicating TXOP sharing and an initial control frame.

After the TDLS procedure between the STA 1-1 and the STA MLD 2 (e.g., STA 2-1 and/or STA 2-2) and/or the TDLS procedure between the STA 1-1 and a STA MLD 3 (e.g., STA 3-1 and/or STA 3-2) is completed, the STA MLD 2 and/or 3 may receive the MU-RTS frame including information indicating the sharing mode 3. In this case, the STA MLD 2 and/or 3 may identify an AID indicated by a user information field included in the MU-RTS frame, and based on the AID, the STA MLD 2 and/or 3 may identify whether the MU-RTS frame is for a STA for which the TDLS procedure has been completed. When the MU-RTS frame is for a STA for which the TDLS procedure has been completed, the STA MLD 2 and/or 3 may transition to the EMLSR operation state if the MU-RTS frame indicates the sharing mode 3.

The AP 1 may add padding bit(s) corresponding to the switching time Ts of the radio chain to a padding field of the MU-RTS frame in consideration of the switching time of the radio chain of the EMLSR STA. When the MU-RTS frame is normally received, the STA 1-1 may transmit a CTS frame to the AP 1 in response to the MU-RTS frame. The AP 1 may receive the CTS frame from the STA 1-1. The P2P setup procedure between the STA 1-1 and the STA 2-1 and/or the P2P setup procedure between the STA 1-1 and the STA 3-1 may be completed, and each of the STA 2-1 and the STA 3-1 may be an EMLSR STA. Each of the STA 2-1 and the STA 3-1 may transition to the EMLSR operation state and may wait in the EMLSR operation state in the first link. Each of the STA 2-1 and STA 3-1 may receive a frame (e.g., CTS frame and/or another frame) after transitioning to the EMLSR operation state. The MAC layer of each of the STA 2-1 and STA 3-1 may receive a PHY-RXSTART.indication, which is a physical layer primitive, from the physical layer. If the PHY-RXSTART.indication is received in the MAC layer of the EMLSR STA within the time Tw from a completion time of the transmission and reception procedure of the frame, the EMLSR STA (e.g., STA 2-1 and/or 3-1) may not transition to the listening operation state.

The STA 1-1 may transmit a data frame to the STA 2-1. The STA 2-1 may receive the data frame from the STA 1-1 and may transmit a response frame to the data frame to the STA 1-1. The STA 1-1 may receive the response frame from the STA 2-1. When the STA 1-1 has one data frame (e.g., data unit) to transmit to the STA 2-1, and there is no data to be additionally transmitted by the STA 1-1, the STA 1-1 may set a ‘more data’ field to 0 and transmit a data frame including the more data field set to 0. In other words, the more data field included in a frame control field of the data frame of the STA 1-1, which is received by the STA 2-1, may be set to 0.

The STA 2-1 may receive the data frame including the more data field set to 0, and may transmit a response frame to the data frame to the STA 1-1. The STA 2-1 may transition from the EMLSR operation state to the listening operation state after a time Tw (or time (Tw+Ts)) from the transmission time of the response frame. Alternatively, the STA 2-1 may transition from the EMLSR operation state to the listening operation state immediately after transmission of the response frame. Alternatively, the STA 2-1 may wait during the time Tw from the transmission time of the response frame, and determine whether to perform the operation of transitioning the operation state (e.g., EMLSR operation state→listening operation state) depending on whether a receiver address indicated by a MAC header of the received frame and an address of the STA 2-1 are identical.

When the receiver address indicated by the MAC header of the received frame is the same as the address of STA 2-1, the STA 2-1 may maintain the EMLSR operation state. When the receiver address indicated by the MAC header of the received frame is different from the address of the STA 2-1, the STA 2-1 may transition to the listening operation state. The STA 2-1 may receive a next data frame from the STA 1-1 and may identify a receiver address of the next data frame. When the receiver address of the next data frame of the STA 1-1 is different from the address of the STA 2-1, the STA 2-1 may transition from the EMLSR operation state to the listening operation state after the time Tw from the transmission time of the previous response frame. Alternatively, when the receiver address of the next data frame of the STA 1-1 is different from the address of STA 2-1, the STA 2-1 may transition from the EMLSR operation state to the listening operation state immediately after transmission of the previous response frame.

The MAC layer of the STA 2-1 may not receive a PHY-RXSTART.indication from the physical layer of the STA 2-1 during the time Tw. In this case, the STA 2-1 may transition from the EMLSR operation state to the listening operation state. The STA 1-1 may transmit a data frame to the STA 3-1 after transmitting the data frame to the STA 2-1. The STA 3-1 may receive the initial MU-RTS frame indicating the sharing mode 3, and the MAC layer of the STA 3-1 may receive a PHY-RXSTART.indication from the physical layer of the STA 3-1. The physical layer of the STA 3-1 may transmit the PHY-RXSTART.indication to the MAC layer of STA 3-1 after normally decoding the frame transmitted and received between the STA 2-1 and the AP. Since the STA 3-1 maintains the EMLSR operation state, the STA 3-1 may receive the data frame from the STA 1-1 without receiving an initial control frame from the STA 1-1.

The STA 3-1 may receive the data frame from the STA 1-1 and may transmit a response frame to the data frame to the STA 1-1. The STA 1-1 may receive the response frame from the STA 3-1. A more data field of the data frame transmitted by the STA 1-1 may be set to 0. In this case, the STA 3-1 may transition from the EMLSR operation state to the listening operation state after the time Tw (or time (Tw+Ts)) from the transmission time of the response frame for the data frame of the STA 1-1. Alternatively, the STA 3-1 may transition from the EMLSR operation state to the listening operation state immediately after transmission of the response frame. Alternatively, the STA 3-1 may receive a next data frame from the STA 1-1 and identify a receiver address of the next data frame. If the receiver address of the next data frame of STA 1-1 is different from the address of the STA 3-1, the STA 3-1 may transition from the EMLSR operation state to the listening operation state after the time Tw from the transmission of the previous response frame. Alternatively, if the receiver address of the next data frame of STA 1-1 is different from the address of the STA 3-1, the STA 3-1 may transition from the EMLSR operation state to the listening operation state immediately after transmission of the previous response frame.

The MAC layer of the STA 3-1 may not receive a PHY-RXSTART.indication from the physical layer of the STA 3-1 during the time Tw. In this case, the STA 3-1 may transition from the EMLSR operation state to the listening operation state. The switching time Ts of the radio chain may be required for the transition operation of the operation states of the EMLSR STAs.

After the STA 2-1 transitions to the listening operation state, the AP 1 may desire to transmit a data frame to the STA 2-1. After the STA 3-1 transitions to the listening operation state, the AP 1 may desire to transmit a data frame to the STA 3-1. The AP 1 may transmit an initial control frame (e.g., MU-RTS frame) to the STA 2-1 and/or STA 3-1 before transmitting data frame(s) to the STA 2-1 and/or STA 3-1. For example, the AP 1 may transmit an MU-RTS frame to the STA 2-1. The STA 2-1 may receive the MU-RTS frame from the AP 1 and may transmit a CTS frame to the AP 1 in response to the MU-RTS frame. The operation state of the STA 2-1 may transition from the listening operation state to the EMLSR operation state. The AP 1 may receive the CTS frame from the STA 2-1. The AP 1 may transmit a data frame to the STA 2-1. In other words, when it is determined that the STA 2-1 is in the EMLSR operation state, the AP 1 may transmit a data frame to the STA 2-1. The STA 2-1 may receive the data frame from the AP 1 and may transmit a response frame to the data frame to the AP 1. The AP 1 may receive the response frame from the STA 2-1.

The STA MLDs 2 and 3 may operate in multiple links (e.g., first link and second link). The STA 2-2 affiliated with the STA MLD 2 and the STA 3-2 affiliated with the STA MLD 3 may operate in the second link. When the STA 2-1 operates in the listening operation state, the STA 2-2 may operate in the listening operation state in the same manner as the STA 2-1. When the STA 3-1 operates in the listening operation state, the STA 3-2 may operate in the listening operation state in the same manner as the STA 3-1. In the listening operation state, each of the STA 2-2 and the STA 3-2 may wait for reception of an initial control frame. When the operation state of the STA 2-1 is the EMLSR operation state, the STA 2-2 may be in the blindness state. When the operation state of the STA 3-1 is the EMLSR operation state, the STA 3-2 may be in the blindness state. In the blindness state, frame transmission and reception operations and/or CCA operations (e.g., channel detection operations) may be impossible.

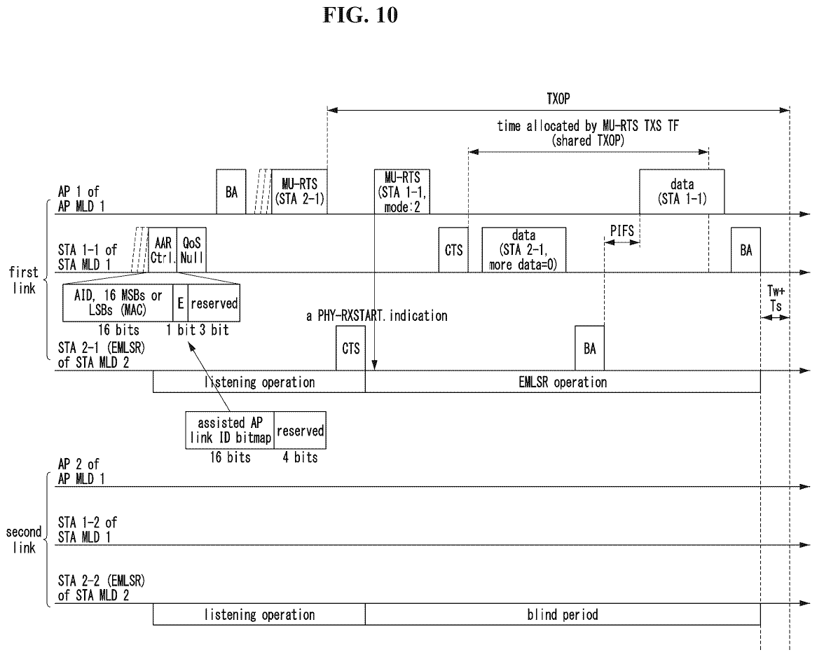

FIG. 10 is a timing diagram illustrating a fourth exemplary embodiment of a direct communication method for an EMLSR STA.

Referring to FIG. 10, in a P2P setup procedure (e.g., TDLS procedure) between the STA MLD 1 and the STA MLD 2, the STA MLD 1 may identify capability information of the STA MLD 2, and the STA MLD 2 may identify capability information of the STA MLD 1. In addition, the STA MLD 1 may identify an AID of the STA MLD 2 in the P2P setup procedure, and the STA MLD 2 may identify an AID of the STA MLD 1 in the P2P setup procedure. The STA MLD 1 may identify that the STA MLD 2 is an EMLSR MLD. In other words, the STA MLD 1 may identify that the STA MLD 2 performs EMLSR operations. Each of the STA 2-1 and the STA 2-2 affiliated with the STA MLD 2 may be an EMLSR STA.

In order to notify the AP 1 that P2P communication between the STA 1-1 and an EMLSR STA is requested, the STA 1-1 may transmit a QoS null frame including an AP assistance requested (AAR) control field to the AP 1. The AAR control field may be one type of an A-control field included in a MAC header of the QoS null frame. The AAR control field may request the AP 1 to transmit an MU-RTS frame to the STA 2-1 affiliated with the STA MLD 2 for transition of the operation state of the STA MLD 2. In other words, the AAR control field may request transition of the STA 2-1 (e.g., EMLSR STA) affiliated with the STA MLD 2 to the EMLSR operation state in the first link. The MU-RTS frame requested by the STA 1-1 may be an initial control frame.

The AAR control field included in the MAC header of the QoS null frame transmitted by the STA 1-1 to the AP 1 may include an AID, 16 high-order bits of a MAC address, or 16 low-order bits of a MAC address of a target STA of the P2P communication instead of the conventional information (e.g., assisted AP link ID bitmap). In other words, the AAR control field may include the address of the target STA of the P2P communication (e.g., direct communication). The size of the assisted AP link ID bitmap may be 16 bits, and the size of the AID of the target STA may be 16 bits. The total size of the AAR control field may be 20 bits. One of the 4 reserved bits of the AAR control field may be configured as an ‘E’ bit (i.e., EMLSR assist request bit). The ‘E’ bit may be set to 0 or 1. When the ‘E’ bit is set to 1, the first 16 bits of the AAR control field may be interpreted as a part of the AID or MAC address of the target STA of the P2P communication. When the ‘E’ bit is set to 0, the first 16 bits of the AAR control field may be interpreted as a link ID (e.g., assisted AP link ID bitmap). The ‘E’ bit may indicate an interpretation scheme of an information element included in the AAR control field. The remaining 3 bits of the AAR control field may be reserved bits. In other words, the remaining 3 bits of the AAR control field may not be used.

Alternatively, an ‘E’ indicator (i.e., EMLSR assist request indicator) having a size of 2 bits may be used. The meaning of the ‘E’ indicator may be defined as shown in Table 3 below. The ‘E’ indicator may indicate an interpretation scheme of an information element included in the AAR control field.

TABLE 3

| ‘E’ | |
|---|---|
| indicator | Description |
| 00 | The first 16 bits of the AAR control field indicates the assisted |
| | AP link ID bitmap |
| 01 | The first 16 bits of the AAR control field indicates the AID of |
| | the EMLSR STA MLD |
| 10 | The first 16 bits of the AAR control field indicates the 16 |
| | high-order bits of the MAC address of the EMLSR STA MLD |
| 11 | The first 16 bits of the AAR control field indicates the 16 |
| | low-order bits of the MAC address of the EMLSR STA MLD |

When the target of P2P communication with the STA 1-1 includes a plurality of EMLSR STA MLDs, the MAC header of the QoS null frame may include as many AAR control fields as the number of the plurality of EMLSR STA MLDs. The STA 1-1 may generate an AAR control field including an ‘E’ bit set to 1 or ‘E’ indicator set to 01, 10, or 11, and transmit a frame including the AAR control field to the AP 1. The AAR control field of the frame transmitted by the STA 1-1 to the AP 1 may include a part of the AID or MAC address of the STA 2-1. When the frame of the STA 1-1 includes a plurality of AAR control fields, a part of the AID or MAC address of each of the plurality of STAs that are to be communicated with the STA 1-1 may be included in the frame. The frame including the AAR control field(s) may be transmitted by the STA 1-1, and one of address fields of the frame may be set to the MAC address of the target STA of P2P communication.

The STA 1-1 may transmit the QoS null frame to the AP 1 to request P2P communication with the EMLSR STA MLD. The AP 1 may receive the QoS null frame from the STA 1-1. The AP 1 may transmit an initial control frame (e.g., MU-RTS frame) to the STA 2-1. The initial control frame may be transmitted to the STA 2-1 (e.g., EMLSR STA) indicated by the QoS null frame. The initial control frame may indicate initiation of an EMLSR reception procedure. The STA 2-1 may receive the initial control frame from the AP 1 and may transmit a CTS frame to the AP 1 in response to the initial control frame. The AP 1 may receive the CTS frame from the STA 2-1. According to the above-described operations, a TXOP of the AP 1 may be configured in the first link.

The STA 2-1 may transition to the EMLSR operation state. When a PHY-RXSTART.indication is received by the MAC layer of the STA 2-1 from the physical layer of the STA 2-1 during the time Tw after the STA 2-1 transitions to the EMLSR operation state (e.g., when the frame is normally decoded regardless of the receiver address of the frame), the STA 2-1 may not transition to the listening operation state. The STA 1-1 may transmit a QoS null frame including a plurality of AAR control fields to perform P2P communication with a plurality of EMLSR STA MLDs. The AP 1 may receive the QoS null frame from the STA 1-1. The AP 1 may sequentially transmit MU-RTS frames (e.g., initial control frames) to the respective plurality of EMLSR STA MLDs indicated by the QoS null frame. The MU-RTS frame may be transmitted to transition the operation state of the EMLSR STA MLD to the EMLSR operation state.

For example, the STA 1-1 may transmit a QoS null frame including an AAR control field indicating an AID of the STA MLD 2 and an AAR control field indicating an AID of the STA MLD 3 to the AP 1. The AP 1 may receive the QoS null frame from the STA 1-1, identify AID(s) included in the QoS null frame, and transmit an MU-RTS frame (e.g., initial control frame) to each of STA(s) having the AID(s) For example, the AP 1 may transmit the MU-RTS frame to the STA 2-1 affiliated with the STA MLD 2. The STA 2-1 may receive the MU-RTS frame from the AP 1 and may transmit a CTS frame to the AP 1 in response to the MU-RTS frame. The AP 1 may receive the CTS frame from the STA 2-1.

The AP 1 may configure a TXOP based on the above-described operations. In other words, the AP 1 may be a holder of the TXOP in the first link. The AP 1 may transmit an MU-RTS frame to the STA 3-1 affiliated with the EMLSR STA MLD 3 after a SIFS from the reception time of the CTS frame of the STA 2-1. The STA 3-1 may receive the MU-RTS frame from the AP 1 and may transmit a CTS frame to the AP 1 in response to the MU-RTS frame. The AP 1 may receive the CTS frame from the STA 3-1.

The QoS null frame may include the AAR control field and a duration information field (e.g., duration field). The duration information field may indicate a time required for direct communication (e.g., P2P communication) between the STA and the EMLSR STA. The AP 1 may transmit an initial control frame (e.g., MU-RTS frame) to transition the operation state of the EMLSR STA MLD to the EMLSR operation state. A duration field included in a MAC header of the MU-RTS frame may be set based on the duration information field included in the QoS null frame.

Alternatively, the STA 1-1 may transmit a response frame (e.g., BA frame) in response to a downlink data frame transmitted by the AP 1. The response frame may have a form of an aggregated-MAC layer protocol data unit (A-MPDU). The response frame having the A-MPDU form may include the QoS null frame including the AAR control field. The QoS null frame included in the response frame in the form of the A-MPDU may indicate an ACK policy as ‘No Ack’.

After the TXOP is configured, the AP 1 may transmit an MU-RTS frame including information indicating sharing of the TXOP to the STA 1-1. The common information field of the MU-RTS frame may include a sharing mode field indicating a sharing mode 2. The sharing mode 2 may indicate initiation of a TXOP sharing procedure. The STA 1-1 may receive the MU-RTS frame (e.g., MU-RTS TXS trigger frame) from the AP 1 and may identify the sharing mode 2 indicated by the MU-RTS frame. The STA 1-1 may transmit a CTS frame to the AP 1 in response to the MU-RTS frame. Upon receiving the MU-RTS frame (e.g., initial control frame) of the AP 1, the STA 2-1 may operate in the EMLSR operation state. Accordingly, the STA 1-1 may transmit a data frame to the STA 2-1 without transmitting an MU-RTS frame. In other words, when it is determined that the STA 2-1 operates in the EMLSR operation state, the STA 1-1 may transmit a data frame to the STA 2-1 without transmitting an MU-RTS frame. When the STA 1-1 receives the MU-RTS frame from the AP 1, when the AP 1 transmits the MU-RTS frame to the STA 2-1, and/or when the STA 2-1 transmits a CTS frame to the AP 1, the STA 1-1 may determine that the STA 2-1 operates in the EMLSR operation state. The STA 2-1 may receive the data frame from the STA 1-1 and may transmit a response frame to the STA 1-1 in response to the data frame. The STA 1-1 may receive the response frame from the STA 2-1. In the above-described exemplary embodiment, the AP 1 may make a transmission order of the MU-RTS TXS trigger frame and a transmission order of the initial control frame different. For example, the AP 1 may first transmit the initial control frame to the STA 2-1, and may share the TXOP by transmitting the MU-RTS TXS trigger frame to the STA 1-1 after receiving the CTS frame.

When the STA 1-1 does not transmit a frame during a PIFS from the reception time of the response frame, the AP 1 may revoke the TXOP shared with the STA 1-1 and transmit a frame to the STA 1-1 or another STA. Alternatively, when an RDG/MorePPDU field included in a MAC header of the frame received from the STA 1-1 is 0, the AP 1 may terminate the TXOP sharing. When there is a frame normally received during the time Tw from the end time of the frame transmission/reception procedure for the STA 2-1 affiliated with the EMLSR STA MLD 2, the STA 2-1 may not transition to the listening operation state. Therefore, even when the AP 1 revokes the shared TXOP and transmits a data frame to another STA (e.g., STA 1-1) during the remaining time within the TXOP, the STA 2-1 may maintain the EMLSR operation state.

The STA MLD 2 may operate in multiple links (e.g., first link and second link). The STA 2-2 affiliated with the STA MLD 2 may operate in the second link. When the STA 2-1 operates in the listening operation state, the STA 2-2 may operate in the listening operation state in the same manner as the STA 2-1. When the operation state of the STA 2-1 is the EMLSR operation state, the STA 2-2 may be in the blindness state. In the blindness state, frame transmission and reception operations and/or CCA operations (e.g., channel detection operations) may be impossible.

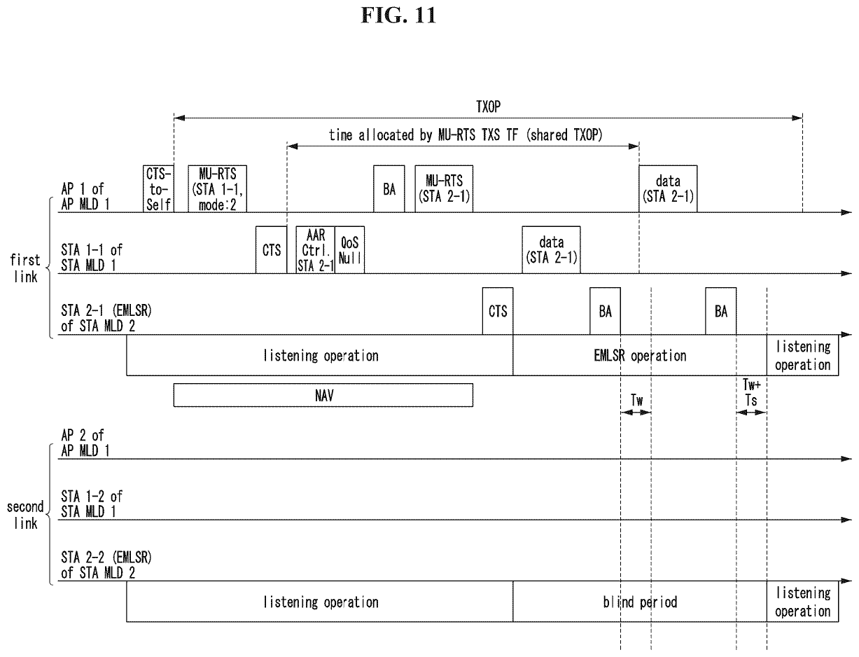

FIG. 11 is a timing diagram illustrating a fifth exemplary embodiment of a direct communication method for an EMLSR STA.

Referring to FIG. 11, the AP 1 may configure a TXOP in the first link by transmitting a CTS-to-Self frame in the first link. Alternatively, the AP 1 may configure a TXOP based on transmission of an RTS frame, reception of a CTS frame, transmission of a data frame, and/or transmission of a trigger frame including a MU-RTS trigger frame in the first link. Alternatively, when the EDCAF of the AP 1 determines transmission as a result of channel contention, the AP 1 may obtain a TXOP. In other words, the AP 1 may be a holder of the TXOP configured in the first link. After configuring the TXOP, the AP 1 may initiate a TXOP sharing procedure for the STA 1-1 by transmitting an MU-RTS frame to the STA 1-1 in the first link. A sharing mode field included in a common information field of the MU-RTS frame transmitted by the AP 1 to initiate the TXOP sharing procedure for the STA 1-1 may be set to 2. The sharing mode 2 may indicate that the MU-RTS frame initiates the TXOP sharing procedure. When the MU-RTS frame of the AP 1 is received, the STA 1-1 may transmit a CTS frame to the AP 1 in response to the MU-RTS frame. The AP 1 may receive the CTS frame from the STA 1-1.

A P2P setup procedure may be performed between the STA MLD 1 and the STA MLD 2. In the P2P setup procedure, capability information of the STA MLD 1 and/or capability information of the STA MLD 2 may be exchanged. For example, the STA MLD 1 may receive the capability information of the STA MLD 2, and the STA MLD 2 may receive the capability information of the STA MLD 1. In addition, the STA MLD 1 may identify an AID of the STA MLD 2 in the P2P setup procedure, and the STA MLD 2 may identify an AID of the STA MLD 1 in the P2P setup procedure. The STA MLD 1 may identify that the STA MLD 2 is an EMLSR MLD. In other words, the STA MLD 1 may identify that the STA MLD 2 performs EMLSR operations. Each of the STA 2-1 and the STA 2-2 affiliated with the STA MLD 2 may be an EMLSR STA.

The STA 1-1 may generate a MAC header including an AAR control field, and may transmit a QoS null frame including the MAC header to the AP 1 within the TXOP. The AP 1 may receive the QoS null frame from the STA 1-1 and may identify the AAR control field included in the QoS null frame. The AAR control field may request the AP 1 to transmit an MU-RTS frame to the STA 2-1 affiliated with the STA MLD 2 for transition of the operation state of the STA MLD 2. In other words, the AAR control field may request transition of the STA 2-1 (e.g., EMLSR STA) affiliated with the STA MLD 2 to the EMLSR operation state in the first link. The AAR control field may request the AP 1 to transmit an MU-RTS frame before the STA 1-1 transmits a data frame to the STA 2-1.

The AAR control field included in the MAC header of the frame transmitted by the STA 1-1 to the AP 1 may include an AID, 16 high-order bits of a MAC address, or 16 low-order bits of a MAC address of a target STA of the P2P communication instead of the conventional information (e.g., assisted AP link ID bitmap). The size of the assisted AP link ID bitmap may be 16 bits, and the size of the AID of the target STA may be 16 bits. The total size of the AAR control field may be 20 bits. One of the 4 reserved bits of the AAR control field may be configured as an ‘E’ bit (i.e., EMLSR assist request bit). The ‘E’ bit may be set to 0 or 1. When the ‘E’ bit is set to 1, the first 16 bits of the AAR control field may be interpreted as a part of the AID or MAC address of the target STA of P2P communication. When the ‘E’ bit is set to 0, the first 16 bits of the AAR control field may be interpreted as a link ID (e.g., assisted AP link ID bitmap). The remaining 3 bits of the AAR control field may be reserved bits. In other words, the remaining 3 bits of the AAR control field may not be used. Alternatively, an ‘E’ indicator (i.e., EMLSR assist request) having a size of 2 bits may be used. The meaning of the ‘E’ indicator may be defined as shown in Table 3 above.

When the target of P2P communication with the STA 1-1 includes a plurality of EMLSR STA MLDs, the MAC header of the QoS null frame may include as many AAR control fields as the number of the plurality of EMLSR STA MLDs. The STA 1-1 may generate an AAR control field including an ‘E’ bit set to 1 or ‘E’ indicator set to 01, 10, or 11, and transmit a frame including the AAR control field to the AP 1. The AAR control field of the frame transmitted by the STA 1-1 to the AP 1 may include a part of the AID or MAC address of the STA 2-1. When the frame of the STA 1-1 includes a plurality of AAR control fields, a part of the AID or MAC address of each of the plurality of STAs that are to be communicated with the STA 1-1 may be included in the frame. The frame including the AAR control field(s) may be transmitted by the STA 1-1, and one of address fields of the frame may be set to the MAC address of the target STA of P2P communication.

The AP 1 may receive the QoS null frame from the STA 1-1, identify the AAR control field included in the QoS null frame, and transmit a response frame (e.g., ACK frame or BA frame) to the STA 1-1 in response to the QoS null frame. The STA 1-1 may receive the response frame for the QoS null frame from the AP 1. The QoS null frame (e.g., AAR control field) of the STA 1-1 may request transmission of an initial control frame (e.g., MU-RTS frame). The AP 1 may transmit an initial control frame (e.g., MU-RTS frame) to the STA 2-1 at the request of the STA 1-1.

The AP 1 may transmit a response frame for the STA 1-1 and an initial control frame for the STA 2-1 based on an orthogonal frequency division multiple access (OFDMA) scheme. In other words, the response frame of the STA 1-1 and the initial control frame of the STA 2-1 may be multiplexed in the frequency domain. A plurality of resource units (RUs) may be configured in the frequency domain. Each of the plurality of RUs may mean a subchannel. The AP 1 may transmit the response frame to the STA 1-1 in a first RU, and may transmit the initial control frame to the STA 2-1 in a second RU. The response frame and the initial control frame may be transmitted within the same time period.

The STA 2-1 may receive the initial control frame (e.g., MU-RTS frame) from the AP 1 and may transmit a CTS frame to the AP 1 in response to the MU-RTS frame. The AP 1 may receive the CTS frame from the STA 2-1. The STA 2-1 may transition to the EMLSR operation state, and may perform a reception operation for a frame during the time Tw from the transition time of the operation state. When the physical layer of the STA 2-1 normally decodes the frame regardless of the receiver address of the received frame, the physical layer of the STA 2-1 may transmit a PHY-RXSTART.indication to the MAC layer of the STA 2-1. In this case, the operation state of the STA 2-1 may not transition to the listening operation state. In other words, the STA 2-1 may maintain the EMLSR operation state.

While the EMLSR STA (e.g., STA 2-1) operates in the EMLSR operation state, the AP or STA may transmit a data frame to the EMLSR STA (e.g., EMLSR STA MLD) without transmitting an initial control frame (e.g., MU-RTS frame). The EMLSR STA may receive the data frame from the AP or STA. An EMLSR transmission/reception procedure between the AP and the EMLSR STA MLD (e.g., EMLSR STA MLD 2) may be initiated due to the initial control frame transmitted by the AP. In the EMLSR transmission and reception procedure, the AP initiating the EMLSR transmission and reception procedure as well as other communication nodes (e.g., STA, other APs) may also transmit data frames within the TXOP corresponding to the duration indicated by the MAC header of the initial control frame (e.g., MU-RTS frame).

After the STA 2-1 transmits the CTS frame to the AP 1, the STA 1-1 may transmit a data frame to the STA 2-1. The STA 2-1 may receive the data frame from the STA 1-1 and may transmit a response frame to the STA 1-1 in response to the data frame. The STA 1-1 may receive the response frame from the STA 2-1.

When the MAC layer of the STA 2-1 does not receive a PHY-RXSTART.indication from the physical layer of the STA 2-1 during the time Tw, the STA 2-1 may transition from the EMLSR operation state to the listening operation state. The switching time Ts of the radio chain in the EMLSR STA may be required for a transition operation between the EMLSR operation state and the listening operation state.

When the STA 1-1 does not transmit a frame during a PIFS and the STA 2-1 does not transition to the listening operation state, when the TXOP sharing period ends (e.g., elapses) and the STA 2-1 does not transition to the listening operation state, or when the TXOP sharing period is yielded by the STA and the STA 2-1 does not transition to the listening operation state, the AP 1 may directly transmit a data frame to the STA 2-1 without transmitting an initial control frame. When the STA 2-1 transitions to the listening operation state, the AP 1 may transmit an initial control frame to the STA 2-1 before transmitting a data frame.

The STA MLD 2 may operate in multiple links (e.g., first link and second link). The STA 2-2 affiliated with the STA MLD 2 may operate in the second link. When the STA 2-1 operates in the listening operation state, the STA 2-2 may operate in the listening operation state in the same manner as the STA 2-1. When the operation state of the STA 2-1 is the EMLSR operation state, the STA 2-2 may be in the blindness state. In the blindness state, frame transmission and reception operations and/or CCA operations (e.g., channel detection operations) may be impossible.

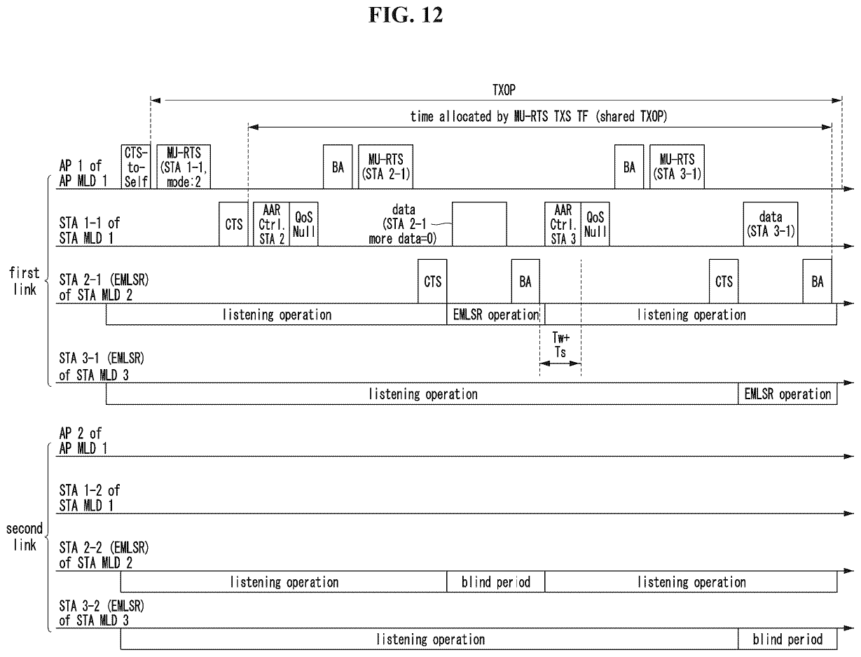

FIG. 12 is a timing diagram illustrating a sixth exemplary embodiment of a direct communication method for an EMLSR STA.

Referring to FIG. 12, the AP 1 may configure a TXOP in the first link by transmitting a CTS-to-Self frame in the first link. Alternatively, the AP 1 may configure a TXOP based on transmission of an RTS frame, reception of a CTS frame, transmission of a data frame, and/or transmission of a trigger frame including a MU-RTS trigger frame in the first link. Alternatively, when the EDCAF of the AP 1 determines transmission as a result of channel contention, the AP 1 may obtain a TXOP. In other words, the AP 1 may be a holder of the TXOP configured in the first link. After configuring the TXOP, the AP 1 may initiate a TXOP sharing procedure for the STA 1-1 by transmitting a MU-RTS frame to the STA 1-1 in the first link. A sharing mode field included in a common information field of the MU-RTS frame transmitted by the AP 1 to initiate the TXOP sharing procedure for the STA 1-1 may be set to 2. The sharing mode 2 may indicate that the MU-RTS frame initiates the TXOP sharing procedure. When the MU-RTS frame of the AP 1 is received, the STA 1-1 may transmit a CTS frame to the AP 1 in response to the MU-RTS frame. The AP 1 may receive the CTS frame from the STA 1-1.

A P2P setup procedure (e.g., TDLS procedure) may be performed for the STA MLD 1, the STA MLD 2, and the STA MLD 3. In the P2P setup procedure, capability information of the STA MLD 1, capability information of the STA MLD 2, and capability information of the STA MLD 3 may be exchanged. For example, the STA MLD 1 may receive the capability information of the STA MLD 2 and/or 3, the STA MLD 2 may receive the capability information of the STA MLD 1 and/or 3, and the STA MLD 3 may receive the capability information of the STA MLD 1 and/or 2. In addition, the STA MLD 1 may identify AIDs of the STA MLD 2 and/or 3 in the P2P setup procedure, the STA MLD 2 may identify AIDs of the STA MLD 1 and/or 3 in the P2P setup procedure, and the STA MLD 3 may identify AIDs of the STA MLD 1 and/or 2 in the P2P setup procedure. The STA MLD 1 may identify that the STA MLDs 2 and 3 are EMLSR MLDs. In other words, the STA MLD 1 may identify that the STA MLD 2 and the STA MLD 3 perform EMLSR operations. Each of the STA 2-1 and the STA 2-2 affiliated with the STA MLD 2 may be an EMLSR STA, and Each of the STA 3-1 and the STA 3-2 affiliated with the STA MLD 3 may be an EMLSR STA.

The STA 1-1 may generate a MAC header including an AAR control field, and may transmit a QoS null frame (or QoS data frame) including the MAC header to the AP 1 within the shared TXOP. The AP 1 may receive the QoS null frame from the STA 1-1 and may identify the AAR control field included in the QoS null frame. The AAR control field may request the AP 1 to transmit an MU-RTS frame to the STA 2-1 affiliated with the STA MLD 2 for transition of the operation state of the STA MLD 2. In other words, the AAR control field may request transition of the STA 2-1 (e.g., EMLSR STA) affiliated with the STA MLD 2 to the EMLSR operation state in the first link. The AAR control field may request the AP 1 to transmit an MU-RTS frame before the STA 1-1 transmits a data frame to the STA 2-1.

The AAR control field included in the MAC header of the frame transmitted by the STA 1-1 to the AP 1 may include an AID, 16 high-order bits of a MAC address, or 16 low-order bits of a MAC address of a target STA of the P2P communication instead of the conventional information (e.g., assisted AP link ID bitmap). The size of the assisted AP link ID bitmap may be 16 bits, and the size of the AID of the target STA may be 16 bits. The total size of the AAR control field may be 20 bits. One of the 4 reserved bits of the AAR control field may be configured as an ‘E’ bit (i.e., EMLSR assist request bit). The ‘E’ bit may be set to 0 or 1. When the ‘E’ bit is set to 1, the first 16 bits of the AAR control field may be interpreted as a part of the AID or MAC address of the target STA of P2P communication. When the ‘E’ bit is set to 0, the first 16 bits of the AAR control field may be interpreted as a link ID (e.g., assisted AP link ID bitmap). The remaining 3 bits of the AAR control field may be reserved bits. In other words, the remaining 3 bits of the AAR control field may not be used. Alternatively, an ‘E’ indicator (i.e., EMLSR assist request indicator) having a size of 2 bits may be used. The meaning of the ‘E’ indicator may be defined as shown in Table 3 above.

When the target of P2P communication with the STA 1-1 includes a plurality of EMLSR STA MLDs, the MAC header of the QoS null frame may include as many AAR control fields as the number of the plurality of EMLSR STA MLDs. Alternatively, QoS null frames as many as the number of the plurality of EMLSR STA MLDs may be generated, and the QoS null frames may be transmitted in the form of an A-MPDU.

The STA 1-1 may generate an AAR control field including an ‘E’ bit set to 1 or ‘E’ indicator set to 01, 10, or 11, and transmit a frame including the AAR control field to the AP 1. The AAR control field of the frame transmitted by the STA 1-1 to the AP 1 may include a part of the AID or MAC address of each of the STA 2-1 and the STA 3-1. When the frame of the STA 1-1 includes a plurality of AAR control fields, a part of the AID or MAC address of each of the plurality of STAs that are to be communicated with the STA 1-1 may be included in the frame. The frame including the AAR control field(s) may be transmitted by the STA 1-1, and one of address fields of the frame may be set to the MAC address of the target STA of P2P communication.

The STA 1-1 may perform P2P communication with a plurality of EMLSR STA MLDs within the shared TXOP. In this case, two schemes may be used. As the first scheme, the STA 1-1 may transmit a QoS null frame (or QoS data frame) including a plurality of AAR control fields to the AP 1. Alternatively, a plurality of QoS null frames (or QoS data frames) may be transmitted to the AP 1 in form of an A-MPDU. The QoS null frame(s) may request the AP 1 to transmit initial control frames (e.g., MU-RTS frame(s)) for EMLSR operations to the STA MLDs. The AP 1 may sequentially transmit the MU-RTS frames to the respective plurality of EMLSR STA MLDs. The above-described operation of the AP 1 may be performed according to the request of the QoS null frame. The MU-RTS frame may be transmitted to transition the operation state of each EMLSR STA MLD to the EMLSR operation state.

For example, the STA 1-1 may transmit a QoS null frame including an AAR control field indicating an AID of the STA MLD 2 and an AAR control field indicating an AID of the STA MLD 3 to the AP 1. The AP 1 may receive the QoS null frame from the STA 1-1, and may identify the AIDs of the respective STA MLDs based on the AAR control fields included in the QoS null frame. The AP 1 may transmit the MU-RTS frame to the STA 2-1 affiliated with the STA MLD 2 having the AID indicated by the QoS null frame. The STA 2-1 may receive the MU-RTS frame from the AP 1 and may transmit a CTS frame to the AP 1 in response to the MU-RTS frame. The AP 1 may receive the CTS frame from the STA 2-1. The operation state of the STA 2-1 may transition from the listening operation state to the EMLSR operation state.

After a SIFS from a time at which the STA 2-1 receives the CTS frame, the AP 1 may transmit a MU-RTS frame to the STA 3-1 affiliated with the STA MLD 3 having the AID indicated by the QoS null frame. The STA 3-1 may receive the MU-RTS frame from the AP 1 and may transmit a CTS frame to the AP 1 in response to the MU-RTS frame. The AP 1 may receive the CTS frame from the STA 3-1. The operation state of the STA 3-1 may transition from the listening operation state to the EMLSR operation state.

The STA 1-1 may identify that the MU-RTS/CTS frame exchange procedure between the AP 1 and the EMLSR STA MLDs (e.g., EMLSR STA MLDs indicated by the AAR control fields) to be communicated with is completed. Thereafter, the STA 1-1 may transmit a data frame to each of the EMLSR STA MLDs at SIFS intervals. Since normal frame(s) are detected at the SIFS intervals, the EMLSR STA MLDs may maintain the EMLSR operation state without transitioning to the listening operation state.

As the second scheme, each of the EMLSR STA MLDs to be communicated may transition to the EMLSR operation state, and then the STA 1-1 may transmit data frames to the EMLSR STA MLDs. The STA 1-1 may transmit a QoS null frame (or QoS data frame) including an AAR control field indicating the AID of STA MLD 2 to the AP 1. The QoS null frame may request the AP 1 to transmit a MU-RTS frame to the EMLSR STA MLD 2. The AP 1 may receive the QoS null frame from the STA 1-1 and may transmit a MU-RTS frame to the STA MLD 2 having the AID indicated by the AAR control field of the QoS null frame. The MU-RTS frame may request the STA MLD 2 to transition to the EMLSR operation state. The STA MLD 2 (e.g., STA 2-1) may receive the MU-RTS frame from the AP 1 and may transmit a CTS frame to the AP 1 in response to the MU-RTS frame. The AP 1 may receive the CTS frame from the STA 2-1. When the MU-RTS frame of the AP 1 is received, the operation state of the STA MLD 2 may transition from the listening operation state to the EMLSR operation state. When the MU-RTS/CTS frame exchange procedure between the AP 1 and the STA 2-1 is completed, the STA 1-1 may transmit a data frame to the STA 2-1.

Thereafter, the STA 1-1 may transmit a QoS null frame (or QoS data frame) including an AAR control field indicating the AID of STA MLD 3 to the AP 1. The QoS null frame may request the AP 1 to transmit a MU-RTS frame to the EMLSR STA MLD 3. The AP 1 may receive the QoS null frame from the STA 1-1 and may transmit a MU-RTS frame to the STA MLD 3 having the AID indicated by the AAR control field of the QoS null frame. The MU-RTS frame may request the STA MLD 3 to transition to the EMLSR operation state. The STA MLD 3 (e.g., STA 3-1) may receive the MU-RTS frame from the AP 1 and may transmit a CTS frame to the AP 1 in response to the MU-RTS frame. The AP 1 may receive the CTS frame from the STA 3-1. When the MU-RTS frame of the AP 1 is received, the operation state of the STA MLD 3 may transition from the listening operation state to the EMLSR operation state. When the MU-RTS/CTS frame exchange procedure between the AP 1 and the STA 3-1 is completed, the STA 1-1 may transmit a data frame to the STA 3-1.

An EMLSR STA in the EMLSR operation state may receive the data frame, and a more data field included in the data frame may be set to 0. In this case, the EMLSR STA may transmit a response frame for the data frame, and may transition to the listening operation state after the time Tw regardless of whether or not a frame is received during the time Tw from the transmission time of the response frame. Alternatively, the EMLSR STA may immediately transition to the listening operation state regardless of whether or not a frame is received during the time Tw from the transmission time of the response frame.

When the more data field included in the data frame received by the EMLSR STA is set to 0, the EMLSR STA may transmit a response frame to the data frame. The EMLSR STA may receive a frame during a time Tw from the transmission time of the response frame, and may identify a receiver address included in a MAC header of the frame by performing a decoding operation on the frame. When the identified receiver address does not indicate the EMLSR STA, the EMLSR STA may transition to the listening operation state after the time Tw. Alternatively, when the identified receiver address does not indicate the EMLSR STA, the EMLSR STA may immediately transition to the listening operation state.

After the STA 2-1 transitions to the listening operation state, the AP 1 may transmit a data frame to the STA 2-1. After the STA 3-1 transitions to the listening operation state, the AP 1 may transmit a data frame to the STA 3-1. The AP 1 may transmit initial control frames (e.g., MU-RTS frames) to the STAs (e.g., STA 2-1 and STA 3-1) before transmission of the data frames. The AP 1 may transmit a MU-RTS frame to the STA 2-1 among the STA 2-1 and the STA 3-1. The STA 2-1 may receive the MU-RTS frame from the AP 1 and may transmit a CTS frame to the AP 1 in response to the MU-RTS frame. The AP 1 may receive the CTS frame from the STA 2-1. The operation state of the STA 2-1 may transition from the listening operation state to the EMLSR operation state. The AP 1 may transmit a data frame to the STA 2-1. The STA 2-1 may receive the data frame from the AP 1 and may transmit a response frame to the AP 1 in response to the data frame. The AP 1 may receive the response frame from the STA 2-1.

The STA MLDs 2 and 3 may operate in multiple links (e.g., first link and second link). The STA 2-2 affiliated with the STA MLD 2 and the STA 3-2 affiliated with the STA MLD 3 may operate in the second link. When the STA 2-1 operates in the listening operation state, the STA 2-2 may operate in the listening operation state in the same manner as the STA 2-1. When the STA 3-1 operates in the listening operation state, the STA 3-2 may operate in the listening operation state in the same manner as the STA 3-1. In the listening operation state, each of the STA 2-2 and the STA 3-2 may wait for reception of an initial control frame. When the operation state of the STA 2-1 is the EMLSR operation state, the STA 2-2 may be in the blindness state. When the operation state of the STA 3-1 is the EMLSR operation state, the STA 3-2 may be in the blindness state. In the blindness state, frame transmission and reception operations and/or CCA operations (e.g., channel detection operations) may be impossible.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first station (STA), comprising:
generating a first frame including a first field including an address of a second STA that is a target of direct communication;
transmitting the first frame to an access point (AP); and
in response to determining that the second STA is operating in an enhanced multi-link single radio (EMLSR) operation state, transmitting a data frame to the second STA at a request of the AP,
wherein the second STA is an EMLSR STA, and the second STA operates in the EMLSR operation state or a listening operation state.

2. The method according to claim 1, wherein the first frame requests the AP to transmit an initial control frame to the second STA.

3. The method according to claim 1, further comprising:
receiving a multi-user (MU)-request-to-send (RTS) frame from the AP after transmitting the first frame; and
transmitting a clear-to-send (CTS) frame to the AP in response to the MU-RTS frame,
wherein when the MU-RTS frame is received, the second STA is determined as operating in the EMLSR operation state, and the data frame is transmitted after transmission of the CTS frame.

4. The method according to claim 3, wherein the MU-RTS frame includes information indicating sharing of a transmission opportunity (TXP) initiated by the AP, and the data frame is transmitted within the TXOP shared by the AP.

5. The method according to claim 1, wherein the first field further includes a first bit indicating an interpretation scheme of an information element included in the first field, the information element is interpreted as an address of the second STA when the first bit is set to a first value, and the information element is interpreted as an assisted AP link ID bitmap when the first bit is set to a second value.

6. The method according to claim 1, wherein the first field further includes an indicator indicating an interpretation scheme of an information element included in the first field, the information element is interpreted as an association identifier (AID) that is an address of the second STA when the indicator is set to a first value, the information element is interpreted as high-order bits of a medium access control (MAC) address that is an address of the second STA when the indicator is set to a second value, the information element is interpreted as low-order bits of a MAC address that is an address of the second STA when the indicator is set to a third value, and the information element is interpreted as an assisted AP link ID bitmap when the indicator is set to a fourth value.

7. The method according to claim 1, wherein the first frame is a quality-of-service (QoS) null frame, the first field is an AP assistance requested (AAR) control field, and an address of the second STA is an AID, high-order bits of a MAC address, or low-order bits of a MAC address.

8. A method of an access point (AP), comprising:
receiving a first frame from a first station (STA);
identifying an address of a second STA that is a target of direct communication with the first STA based on a first field included in the first frame; and
transmitting an initial control frame to the second STA,
wherein the second STA is an enhanced multi-link single radio (EMLSR) STA, and the second STA operates in an EMLSR operation state or a listening operation state.

9. The method according to claim 8, further comprising:
transmitting a multi-user (MU)-request-to-send (RTS) frame including information indicating sharing of a transmission opportunity (TXOP) initiated by the AP to the first STA; and
receiving a clear-to-send (CTS) frame from the first STA in response to the MU-RTS frame,
wherein the direct communication between the first STA and the second STA is performed within the TXOP shared by the AP.

10. The method according to claim 8, wherein the first frame requests the AP to transmit the initial control frame to the second STA.

11. The method according to claim 8, wherein the first field further includes a first bit indicating an interpretation scheme of an information element included in the first field, the information element is interpreted as an address of the second STA when the first bit is set to a first value, and the information element is interpreted as an assisted AP link ID bitmap when the first bit is set to a second value.

12. The method according to claim 8, wherein the first field further includes an indicator indicating an interpretation scheme of an information element included in the first field, the information element is interpreted as an association identifier (AID) that is an address of the second STA when the indicator is set to a first value, the information element is interpreted as high-order bits of a medium access control (MAC) address that is an address of the second STA when the indicator is set to a second value, the information element is interpreted as low-order bits of a MAC address that is an address of the second STA when the indicator is set to a third value, and the information element is interpreted as an assisted AP link ID bitmap when the indicator is set to a fourth value.

13. The method according to claim 8, wherein the first frame is a quality-of-service (QoS) null frame, the first field is an AP assistance requested (AAR) control field, and an address of the second STA is an AID, high-order bits of a MAC address, or low-order bits of a MAC address.

14. A first station (STA) comprising a processor, wherein the processor causes the first STA to perform:
generating a first frame including a first field including an address of a second STA that is a target of direct communication;
transmitting the first frame to an access point (AP); and
in response to determining that the second STA is operating in an enhanced multi-link single radio (EMLSR) operation state, transmitting a data frame to the second STA at a request of the AP,
wherein the second STA is an EMLSR STA, and the second STA operates in the EMLSR operation state or a listening operation state.

15. The first STA according to claim 14, wherein the first frame requests the AP to transmit an initial control frame to the second STA.

16. The first STA according to claim 14, wherein the processor further causes the first STA to perform:
receiving a multi-user (MU)-request-to-send (RTS) frame from the AP after transmitting the first frame; and
transmitting a clear-to-send (CTS) frame to the AP in response to the MU-RTS frame,
wherein when the MU-RTS frame is received, the second STA is determined as operating in the EMLSR operation state, and the data frame is transmitted after transmission of the CTS frame.

17. The first STA according to claim 16, wherein the MU-RTS frame includes information indicating sharing of a transmission opportunity (TXP) initiated by the AP, and the data frame is transmitted within the TXOP shared by the AP.

18. The first STA according to claim 14, wherein the first field further includes a first bit indicating an interpretation scheme of an information element included in the first field, the information element is interpreted as an address of the second STA when the first bit is set to a first value, and the information element is interpreted as an assisted AP link ID bitmap when the first bit is set to a second value.

19. The first STA according to claim 14, wherein the first field further includes an indicator indicating an interpretation scheme of an information element included in the first field, the information element is interpreted as an association identifier (AID) that is an address of the second STA when the indicator is set to a first value, the information element is interpreted as high-order bits of a medium access control (MAC) address that is an address of the second STA when the indicator is set to a second value, the information element is interpreted as low-order bits of a MAC address that is an address of the second STA when the indicator is set to a third value, and the information element is interpreted as an assisted AP link ID bitmap when the indicator is set to a fourth value.

20. The first STA according to claim 14, wherein the first frame is a quality-of-service (QoS) null frame, the first field is an AP assistance requested (AAR) control field, and an address of the second STA is an AID, high-order bits of a MAC address, or low-order bits of a MAC address.
